(19) United States
(12) Patent Application Publication
(10) Pub. No.: US 2015/0347954 A1
(43) Pub. Date: Dec. 3, 2015

(54) MATCHING SYSTEM

(71) Applicant: JungoLogic, Inc., Steamboat Springs, CO (US)

(72) Inventors: Carol Anne Stern, Steamboat Springs, CO (US); Kevin L. Painter, Green Bay, WI (US); Shawn E. Dezego, Chuluota, FL (US); Timothy D. Brewington, Memphis, TN (US)

(21) Appl. No.: 14/589,430

(22) Filed: Jan. 5, 2015

Related U.S. Application Data
(60) Provisional application No. 62/006,618, filed on Jun. 2, 2014.
(60) Provisional application No. 62/085,910, filed on Dec. 1, 2014.

(51) Int. Cl. G06Q 10/06; G06F 17/30

(52) U.S. Cl. CPC G06Q 10/063112; G06F 17/30477

(57) ABSTRACT

A system for matching an employer with a job seeker implemented with a processor and memory including a set of instructions executable by the processor. The instructions may be executable to configure the processor to create an initial job posting profile, process a review of the initial job posting profile, create a final job posting profile, process answers from job seekers in response to survey questions related to attributes of the job seeker, create a job seeker profile, and compare a job seeker profile with a final job posting profile to create list of top job seekers. The final job posting profile may include attributes, where an attribute may include an intensity level applied thereto. The intensity level of an attribute in final job posting profiles may be compared to an intensity level of an attribute as indicated in job seeker profiles to create the list of top job seekers.

### CROSS-REFERENCE TO RELATED APPLICATIONS

This application claims priority under 35 U.S.C. §119 to U.S. Provisional Application Ser. No. 62/006,618, filed Jun. 2, 2014, the entirety of which is incorporated herein by reference. This application claims priority under 35 U.S.C. §119 to U.S. Provisional Application Ser. No. 62/085,910, filed Dec. 1, 2014, the entirety of which is incorporated herein by reference.

### TECHNICAL FIELD

The disclosure is directed to job matching systems. More particularly, the disclosure is directed to job matching systems which facilitate determining desirable job seekers for an open job position and desirable open job positions for a job seeker.

### BACKGROUND

Job seekers send out cover letters, fill out resumes, and interview for jobs, while employers are forced to look through all of those cover letters and resumes received from job seekers to identify qualifying candidates and then interview those qualifying candidates. As such, employers spend time and resources during efforts associated with finding, evaluating, and hiring job seekers and job seekers spend time and resources while looking for suitable job positions, filing applications with potential employers, and interviewing with potential employers. Even so, once an employer identifies a believed-to-be ideal job seeker, the job seeker may not be interested in the position offered by the employer. Similarly, once a job seeker identifies a believed-to-be ideal job opening, the employer may not be interested in the job seeker. Furthermore, despite expending resources associated with identifying and hiring for a vacant position and/or applying for a vacant position, there is limited certainty that the expended resources will lead to a successful candidate and/or job search for employers and/or job seekers, respectively.

### SUMMARY

The disclosure is directed to several alternative or complementary matching systems and methods of using matching systems. Although it is noted that conventional matching systems including systems for filling job openings exist, there is an ongoing need for improvement on those systems.

Accordingly, an illustrative embodiment of the disclosure is a matching system for matching job seekers with available job openings. The system may include, for example, a job posting profile module, a job seeker profile module, and a processor in communication with the job posting profile module and the job seeker profile module. The job posting profile module may include one or more job posting profiles. In one example, a job posting profile may include one or more behavioral traits of a desirable job seeker for filling an open job position. The job seeker profile module may include one or more job seeker profiles. In one example, a job seeker profile may include an associated job seeker's answers to survey questions related to one or more behavioral traits. The processor may be configured to create a job seeker score for one or more of the behavioral traits in a job and, in some instances, determine total weighted score for the job seeker with respect to the job posting profile.

The above summary of some example aspects is not intended to describe each disclosed embodiment or every implementation of the claimed disclosure.

### BRIEF DESCRIPTION OF THE DRAWINGS

The disclosure may be more completely understood in consideration of the following detailed description of various embodiments in connection with the accompanying drawings, in which:

FIG. 1 is a schematic diagram of an illustrative matching system for matching job seekers with job postings and/or job postings with job seekers;

FIG. 2 is a schematic flow diagram of an illustrative method of operation for a matching system matching job seekers with job postings and/or job postings with job seekers;

FIG. 3 is a schematic flow diagram of an illustrative method of creating a job posting profile for a matching system matching job seekers with job postings and/or job postings with job seekers;

FIG. 4 is a schematic flow diagram of an illustrative method of processing answers from job seekers for a matching system matching job seekers with job postings and/or job postings with job seekers;

FIG. 5 is a schematic flow diagram of an illustrative method of comparing job seekers to job postings for a matching system matching job seekers with job postings and/or job postings with job seekers;

FIG. 6 is a schematic flow diagram of an illustrative method of performing an “ignore list” evaluation for a matching system matching job seekers with job postings and/or job postings with job seekers;

FIG. 7 is a schematic flow diagram of an illustrative method of preforming an industry specific evaluation for a matching system matching job seekers with job postings and/or job postings with job seekers;

FIG. 8 is a schematic flow diagram of an illustrative method of performing an education level evaluation for a matching system matching job seekers with job postings and/or job postings with job seekers;

FIG. 9 is a schematic flow diagram of an illustrative method of performing a salary range evaluation for a matching system matching job seekers with job postings and/or job postings with job seekers;

FIG. 10 is a schematic flow diagram of an illustrative method of performing a work experience match evaluation for a matching system matching job seekers with job postings and/or job postings with job seekers;

FIG. 11 is a schematic flow diagram of an illustrative method of performing a willingness to travel evaluation for a matching system matching job seekers with job postings and/or job postings with job seekers;

FIG. 12 is a schematic flow diagram of an illustrative method of performing a prior work history match evaluation for a matching system matching job seekers with job postings and/or job postings with job seekers;

FIG. 13 is a schematic flow diagram of an illustrative method of performing a geographic location match evaluation for a matching system matching job seekers with job postings and/or job postings with job seekers;

FIG. 14 is a schematic flow diagram of an illustrative method of performing a minimum matching score evaluation for a matching system matching job seekers with job postings and/or job postings with job seekers;

FIG. 15 is a schematic flow diagram of an illustrative method of calculating a total weighted score for a matching system matching job seekers with job postings and/or job postings with job seekers;

FIG. 16 is a schematic diagram of an illustrative matrix used in calculating a total weighted score for a matching system matching job seekers with job postings and/or job postings with job seekers; and

FIG. 17 is a schematic diagram of illustrative communications between a job seeker and an employer for a matching system matching job seekers with job postings and/or job postings with job seekers.

While the disclosure is amenable to various modifications and alternative forms, specifics thereof have been shown by way of example in the drawings and will be described in detail. It should be understood, however, that the intention is not to limit aspects of the claimed disclosure to the particular embodiments described. On the contrary, the intention is to cover all modifications, equivalents, and alternatives falling within the spirit and scope of the claimed disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

As used herein, numerical or other order designations of elements (e.g., first, second, third, a, b, c, etc.) are used for descriptive purposes to improve the clarity of the description of the disclosure and differentiate between similar disclosed features. These numerical indications, unless expressly indicated, are not used for any limiting purposes.

The following detailed description should be read with reference to the drawings in which similar elements in different drawings are numbered the same. The detailed description and the drawings, which are not necessarily to scale, depict illustrative embodiments and are not intended to limit the scope of the claimed disclosure. The illustrative embodiments depicted are intended only as exemplary. Selected features of any illustrative embodiment may be incorporated into an additional embodiment unless clearly stated to the contrary.

To fill vacant positions and/or job openings, organizations or employers may rely upon information provided thereto by a candidate for the job or a job seeker through, for example, a cover letter, curriculum vitae, and/or a resume. Organizations or employers may review the provided materials then make a decision as to whether it is desired to further consider the candidate or job seeker for one or more open positions based upon the information provided by the candidate or job seeker and/or other publicly available information about the candidate or job seeker. On the other hand, to obtain employment, a job seeker may review several different job postings by several different organizations or employers and then make decisions as to which job postings should be pursued and eventually as to which job posting a cover letter, curriculum vitae, and/or a resume should be submitted for consideration.

As described in the Figures and disclosed herein, a matching system 10 may facilitate matching one or more job seekers 12 with a job opening of an employer 14 and/or one or more job openings of one or more employers 14 with a job seeker 12. Illustratively, the matching system 10 may include a database of job openings or job postings (e.g., a job posting profile module) and a database of job seekers (e.g., a job seeker profile module), and the matching system 10 may use empirical data and/or other data to match one or more job seekers 12 with one or more employers 14 associated with one or more job openings in the database, and vice versa. When one or more of a job seeker 12 and an employer 14 that are matched want to communicate with one another over potential matches, the matching system 10 may offer one or more communication techniques that may facilitate refining the likelihood of a successful match between a job seeker 12 and a job opening of an employer 14 and/or may facilitate providing better matches for the job seeker 12 and/or the employer 14 over time, as explained in further detail below.

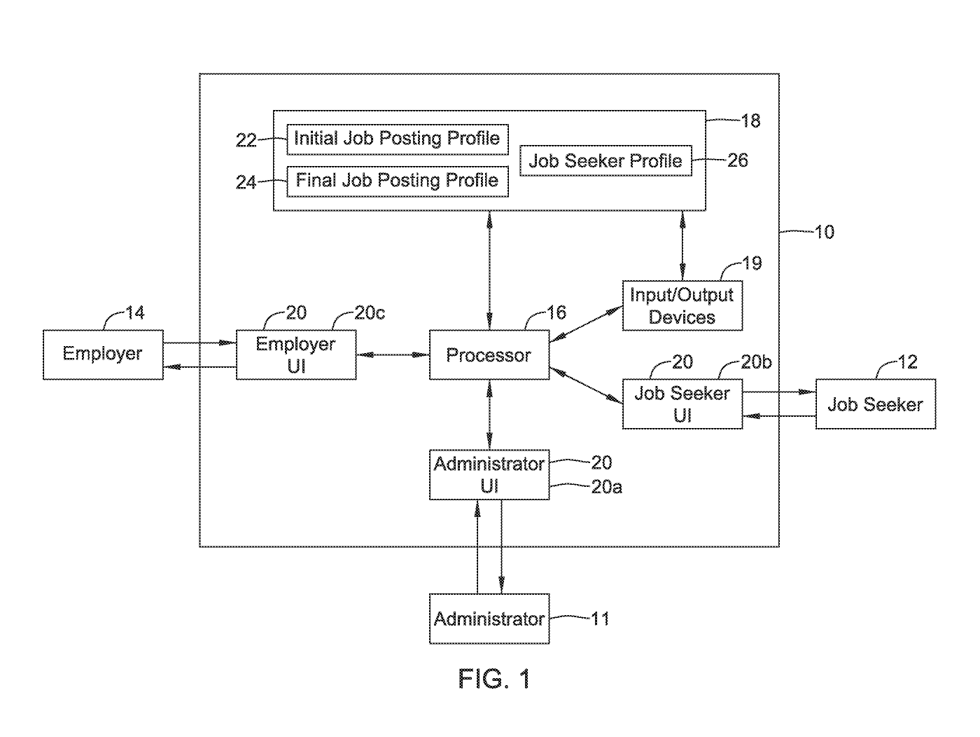

The matching system 10 may be implemented on a suitable general-purpose computer with sufficient processing power, memory resources, and network throughput capability to handle the necessary workload placed thereon, where suitable general-purpose computers may be configured to execute instructions to effect the matching system 10. As shown in FIG. 1 for example, the matching system 10 may include and/or may be implemented with a processor 16, memory 18, input/output connections/devices 19, and/or a display for viewing and/or interacting with one or more user interfaces 20, where the processor 16, the memory 18, and the user interfaces 20 are in communication with one another and one or more databases or modules of the matching system 10 are accessible through the user interfaces 20. The memory 18 may include one or more sets of instructions (e.g., software, firmware, and/or other computer executable instructions) that may be executable by the processor 16 to effect functionality of the matching system 10 through the user interfaces 20.

The processor 16 may be a suitable type of processor and may include one or more processors. Illustratively, the processor 16 may be a suitable type of central processing unit, microprocessor commonly found in computing devices including, but not limited to, servers, desktop computers, mobile computing devices, laptops, telephones, tablets, and/or other computing devices, and/or a different suitable type of processor. In some examples, the processor 16 may be configured to save, record, execute, and/or operate software, firmware, and/or other computer executable instructions on or in a non-transitory computer readable medium (e.g., memory 18 or other non-transitory computer readable medium).

The memory 18 may be a suitable type of memory. For example, the memory 18 may include one or more types of memory, including but not limited to random access memory (RAM), read only memory (ROM), FLASH memory, electrically erasable programmable read only memory (EEPROM) and/or other type of memory capable of saving thereon one or more of software, firmware, and other computer executable instructions.

In some instances, one or more portions of the memory 18 may be located at or near the processor 16 and/or one or more portions of the memory 18 may be remotely located from the processor 16 and accessible through the internet and/or an intranet. In some cases, the processor 16 and/or the memory 18 may include or may be included with one or more servers. In one example of utilizing the memory 18 and processor 16, the databases and/or modules of the matching system 10 may be stored on the memory 18 and accessed by the processor 16.

As discussed, the matching system 10 may be accessible through one or more user interfaces 20. In one illustrative example, the matching system 10 may be accessible by an administrator 11 through an administrator user interface 20a, by a job seeker 12 through a job seeker user interface 20b, and/or by an employer 14 through an employer user interface 20c. The user interfaces 20 of the matching system 10 may be a suitable type of user interface and may be a software application, a software program, and/or a web page accessible via a web browser on one or more types of general computing devices (e.g., personal computers, desktop computers, telephones, tablet computers, and/or other computing device). Alternatively, or in addition, a user (e.g., a job seeker 12, an employer 14, an administrator 11 and/or other user) may access the user interface 20 (e.g., where the user interface 20 may include a call center or a brick and mortar type (e.g., physical type) building accessible to a job seeker 12 or employer 14) of the matching system 10 through one or more of a telephone call, video conferencing, and/or through an in-person interaction with a representative associated with the matching system 10.

Each of the user interfaces 20 may be different in one or more manners and/or may be the same in one or more manners. In some cases, each of the user interfaces 20 may include user dependent displays and/or information intended for its end user (e.g., administrator 11, job seeker 12, and/or employer 14). In one example, the user interfaces 20 may have one or more common initial pages that are accessible to all users. For example, the common initial page or pages may include information about the matching system 10 in general, reviews of the matching system 10, and/or information about what using the matching system 10 may be like. In some instances, the one or more common initial pages may include matching system 10 operation information, cost information, reviews, experiences, terms of services, and/or other information about the matching system 10. From the common initial page or pages, users may enter username and/or password information to access one or more of the administrator user interface 20a, the job seeker user interface 20b, and/or the employer user interface 20c. The user specific user interfaces 20a, 20b, 20c may provide access to information and/or pages within the matching system 10 that are directed to a particular type of user and/or user specific information, which is further described below.

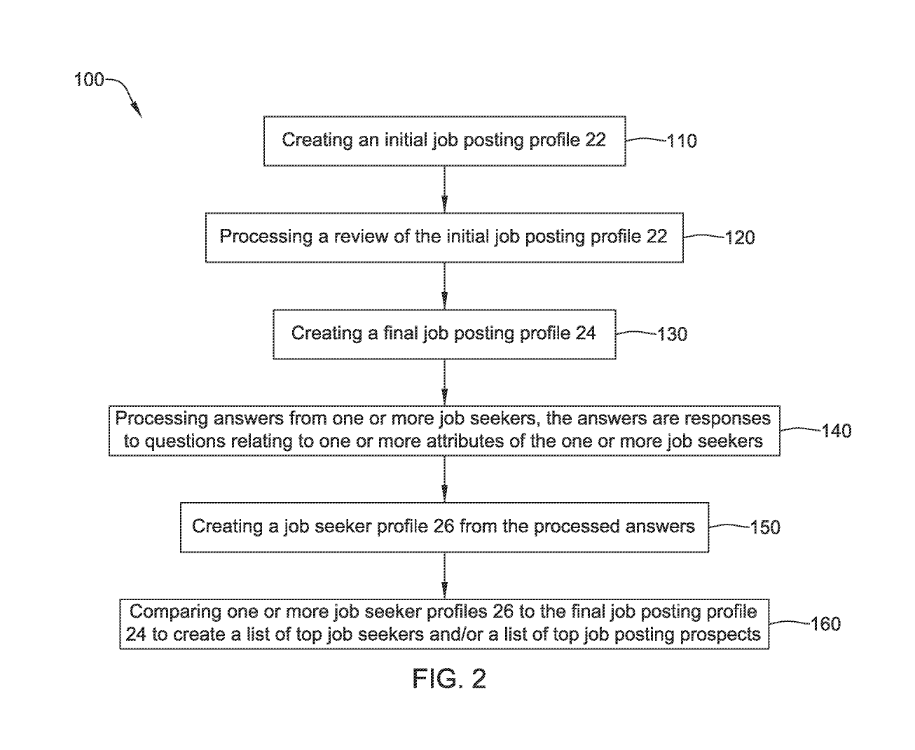

The matching system 10 may operate with respect to one or more methods that may manifest in computer executable instructions in the memory 18 to configure the processor 16 to effect the matching system 10. In one example, a method 100 of the matching system 10, as shown in the flow diagram of FIG. 2, may include creating 110 an initial job posting profile 22 for a job posting or job opening of an employer 14, processing 120 a review of the initial job posting profile, creating 130 a final job posting profile 24, processing 140 answers from one or more job seekers 12, creating 150 a job seeker profile 26, and comparing 160 one or more job seeker profiles 26 to one or more final job posting profiles 24. The features of the method 100 and the other methods described herein may be performed in another logical order and are not limited in order by the numerical numbering unless the order of the features of the methods is specifically addressed.

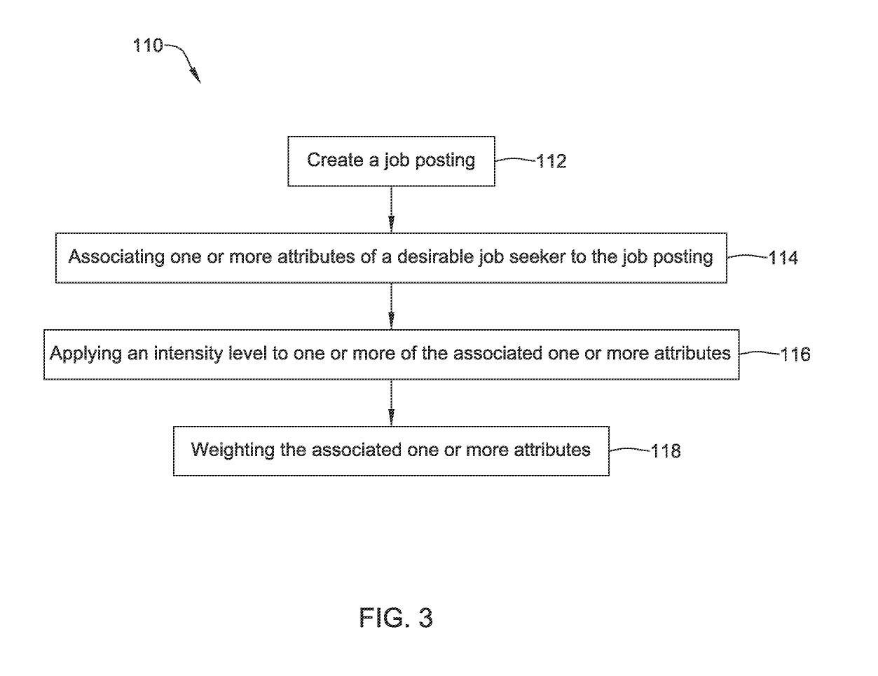

Creating 110 an initial job posting profile 22 may include one or more elements, as shown for example in FIG. 3. In one example, creating 110 the initial job posting profile 22 may include an employer 14 creating 112 a new job posting, the matching system 10 applying or associating 114 one or more attributes of a desirable job seeker 12 to the created new job posting, the matching system 10 applying or associating 116 an intensity level (described in more detail below) to one or more of the associated one or more attributes, and the matching system 10 ordering, ranking, and/or weighting 118 each of the associated one or more attributes, but the application of the intensity level and/or the ordering, ranking, and/or weighting is not necessarily required in all instances.

As used herein, a “desirable job seeker” is a job seeker 12 that may have a threshold number of attributes in common with attributes associated with a job posting, where the matching system 10 may determine if the threshold number of attributes has been met such that a job seeker 12 may be considered a “desirable job seeker”. A threshold number of matching attributes may be one attribute match between a final job posting profile 24 and a job seeker profile 26, may be a one hundred percent attribute match between the final job posting profile 24 and the job seeker profile 26, and/or any other percent match of attributes (e.g., demographic and/or behavioral) therebetween.

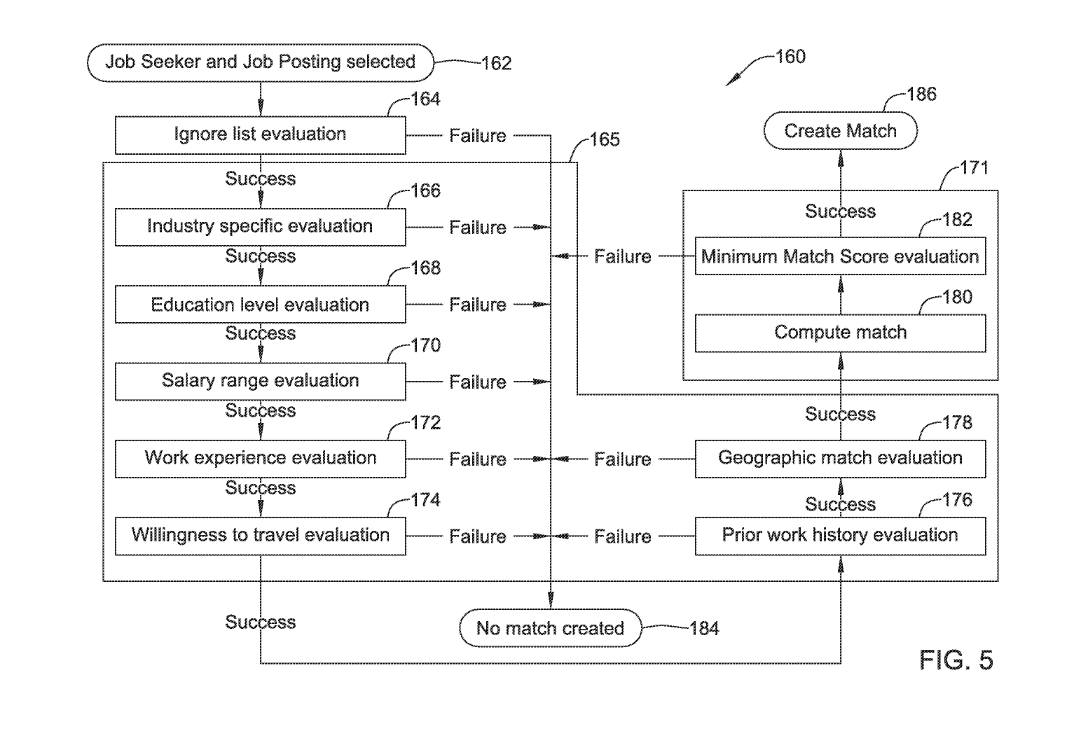

In one example of determining whether a job seeker 12 is a desirable job seeker, the matching system 10 may determine a job seeker 12 is a desirable job seeker if the job seeker 12 meets all demographic attributes associated with a particular job posting and/or has a requisite match of behavioral trait attributes with behavioral trait attributes associated with the particular job posting (e.g., a requisite match of intensity level, ordering, ranking, and/or weighting of the behavioral traits or other requisite match), as discussed below with respect to FIGS. 5-14. Alternatively, or in addition, the matching system 10 may determine a job seeker 12 is a desirable job seeker if the job seeker 12 has one or more other threshold numbers of attributes in common with attributes associated with the job posting.

To create a new job posting, an employer 14 (e.g., a job agent of or associated with an employer, a human resources employee of an employer, and/or other individual or machine of an employer) may interact with the employer user interface 20c and list one or more details of a job opening. In one example, the employer 14 may answer one or more questions that relate to describing the nature of the work to be performed by an employee filling the job opening and/or relate to the type of industry or industries in which the employer operates. Answering the questions may include answering specific questions and/or filling in one or more fields with information describing the nature of the work to be performed by an employee filling the job opening, describing the type of industry or industries in which the employer operates, and/or providing any other information related to the job opening and/or a desirable job seeker for the job opening.

In some cases, but not necessarily all, when an employer 14 is creating a new job posting to be used by the matching system 10 to create an initial job posting profile 22, (as discussed below), the employer 14 may be prohibited from providing some (e.g., specific types of) or any information related to desired attributes of a job seeker that may fill the job opening so as to avoid adding employer bias to the process of the matching system 10 at this stage of a matching process. In one illustrative example, for the purpose of avoiding or limiting the addition of employer bias to the process of creating an initial job posting profile 22 with the matching system 10, an employer 14 may be prohibited within the matching system 10 from providing any information related to desired behavioral traits of a desirable job seeker 12 that may fill the job opening of the employer 14 when creating a new job posting. Alternatively, an employer 14 may be able to provide some information related to desired behavioral traits of a desirable job seeker 12 that may fill the job opening of the employer and then, the matching system 10 may consider any inherent bias in the provided information and/or in how the provided information was collected when creating the initial job posting profile 22.

A suitable number and/or a suitable type of questions related specifically to the job posting may be posed to the employer 14. For example, sample questions may include, but are not limited to “What type of position is the job opening?”, “How many years of experience does this job position require?”, “What are the performance requirements for the job posting?” (e.g., “What is the average on target earnings for the position of the job posting?”, when the job posting is for a sales job), “What is the average amount of travel time for this job posting?”, “What is the educational degree requirement for this job posting?”, “What is the level of this job posting within the employer's corporate hierarchy?”, and/or other questions.

In some instances, questions asked of the employer 14 when creating 112 a job posting may include one or more questions that directly or indirectly relate to one or more behavioral traits of a desirable job seeker to fill the open position of the job posting. Where the question is indirectly, and sometimes when the question is directly, related to one or more behavioral traits of a desirable job seeker, the question may be designed to facilitate the matching system 10 in applying one or more attributes (e.g., behavioral trait) to the initial job posting profile 22 by receiving input from the employer 14 without allowing the employer's bias to play a role in associating attributes with the job posting in the initial job posting profile 22, as one example purpose, among other purposes, of utilizing the matching system 10 may be to remove employer 14 and/or job seeker 12 bias from one or more particular stages of a hiring process.

The employer 14 may have an employer profile within the matching system 10. The employer profile may include past job postings by the employer 14 and/or past final job posting profiles 24, the industry or industries of the employer, the location(s) of the employer 14, the corporate culture of the employer, the management style of the employer, and/or other demographic information (e.g., demographic ideals) related to the employer 14. Some or all of the information in an employer profile may be selectively or automatically applied to job postings created by the employer 14.

In response to receiving a job posting from an employer 14, the matching system 10 may apply or associate 114 (e.g., suggest) one or more attributes of a desirable job seeker 12 to the job posting to create the initial job posting profile 22. The matching system 10 may associate one or more attributes for a desirable job seeker 12 with the job posting based on the information provided in the job posting, including, but not limited to, the type of job opening (e.g., types of job openings may include sales associate, attorney, accountant, nurse, doctor, retail clerk, data entry, and/or other types of similar or dissimilar job openings), salary requirements, travel time requirements, location requirements, degree requirements, and/or other types of job opening related information.

The one or more attributes may include one or more behavioral traits of a desirable job seeker for the job opening and one or more pieces of demographic information (e.g., demographic ideals that may include, but are not limited to, salary requirements, travel time, location and/or other demographic information related to the job opening). In one example set of behavioral traits selectable by the matching system 10, the behavioral traits may be situated in a behavioral trait database in the memory 18, where the behavioral trait database may include, but is not limited to, the following behavioral traits: adaptability, ability to be amiable, ability to be assertive, ability to be charismatic, ability to be coached, ability to commit, ability to communicate, ability to compete, ability to be compliant, ability to be confident, ability to be creative, ability to be decisive, ability to delegate, ability to be deliberate, dependability, ability to be disciplined, ability to be driven, ability to be empathetic, ability to listen, ability to be independent, ability to be influential, ability to be inquisitive, integrity, ability to lead, ability to manage, ability to negotiate, ability to be optimistic, ability to organize, ability to be passionate, ability to be technical, ability to be a visionary, and/or other similar or dissimilar behavioral traits.

A suitable number of attributes (e.g., a suitable number of behavioral traits and/or a suitable amount of demographic information) may be applied to and/or associated with a job posting by the matching system 10. For example, one behavioral trait, two behavioral traits, three behavioral traits, four behavioral traits, five behavioral traits, six behavioral traits, seven behavioral traits, eight behavioral traits, nine behavioral traits, ten behavioral traits, fifteen behavioral traits, and so on, or a range of behavioral traits such as up to five behavioral traits, up to ten behavioral traits, up to fifteen behavioral traits, between one and twenty behavior traits, between one and fifteen behavioral traits, between one and ten behavioral traits, between one and five behavioral traits, between five and ten behavioral traits, or other range of behavioral traits may be applied to and/or associated with a job posting. In some cases, the matching system or an employer 14 may be able to select a number of behavioral traits to apply to and/or associate with a job posting. In one example, an employer may be able to choose up to five behavioral traits, up to ten behavioral traits, up to fifteen behavioral traits, up to twenty behavioral traits, and so on when reviewing an initial job posting profile 22.

In some instances, an intensity level may be applied to and/or associated with one or more of the attributes that are applied to and/or associated with a job posting (e.g., by the matching system 10 and approved or modified by an employer 14, or in one or more other manners). For example, the behavioral traits of a job posting may have an intensity applied thereto and/or associated therewith. Illustratively, an intensity level applied to and/or associated with a trait may indicate how strong an ideal or desirable job seeker candidate is to exhibit the trait, where the intensity level of a behavioral trait of a job seeker 12 may be determined based on answers the job seeker 12 provides to questions of a psychometric test that tests job seekers 12 for exhibited behavioral traits and/or a strength or intensity of those exhibited behavioral traits. How well a job seeker's 12 intensity level for a particular behavioral trait matches an intensity level for that trait in a final job posting profile 24 is described in greater detail below.

Such matching of intensity level for a behavioral trait may be desirable to determine how well a job seeker 12 may fit a position within an employer's culture or industry. For example, if it is desirable for a job seeker 12 to be optimistic (e.g., where optimism is a desired behavioral trait) but it is desirable for the job seeker 12 to be moderately optimistic and rather undesirable for a job seeker 12 to be too highly optimistic, an employer 14 may benefit from knowing whether a job seeker 12 is a moderately optimistic job seeker 12 (e.g., has a moderate intensity level for optimism) or an overly optimistic job seeker 12 (e.g., has a high intensity level for optimism).

An intensity level applied to and/or associated with a behavioral trait in a final job posting profile 24 may be based on a numerical scale or other metric. In one example, an intensity level applied to and/or associated with a behavioral trait may be based on a five point scale, where a 1 may indicate a low intensity, a 2 may indicate a low medium intensity, a 3 may indicate a medium intensity, a 4 may indicate a medium high intensity, and a 5 may indicate a high intensity. Alternatively, or in addition, other scales having more points or less points than five points may be utilized as desired for a numerical scale.

Although intensity level metrics for behavioral traits are discussed herein, other characteristics may be measured, as desired, to assist in identifying the desirability of a job seeker 12 for a particular job posting. For example, other characteristics may be measured to determine, among other things, in what situations a job seeker 12 may exude a behavioral trait, an ability of the job seeker 12 to exude a trait under pressure, and so on.

In some instances, the attributes applied to and/or associated with the job posting may be ordered, ranked, and/or weighted 118 in one or more manners (e.g., by the matching system 10 or in one or more other manners). For example, the behavioral traits of the associated attributes may be ordered, ranked, and/or weighted 116 by the matching system 10 in one or more manners. In one instance, the behavioral traits may be weighted by the matching system 10 according to order of importance for the created job posting (e.g., by most desirable trait to least desirable trait based on the information received from the employer when the job posting is created and/or based on the algorithms of the matching system 10). Additionally, or alternatively, an employer may modify the weights the matching system 10 applies to the behavioral traits or apply its own weights to the behavioral traits.

In one example of weighting behavioral traits applied to or associated with a job posting, each behavioral trait may be weighted twenty percent (20%) less than the behavioral trait ranked one step more important, more relevant, or more desirable. Illustratively, a first behavioral trait may have a weighted score of one hundred (100), a second behavioral trait may have a weighted score of eighty (80), a third behavioral trait may have a weighted score of sixty-four (64), a fourth behavioral trait may have a weighted score of fifty-one (51), and a fifth behavioral trait may have a weighted score of forty-one (41), where non-integer weights may be rounded to the nearest integer. Such a set of behavioral traits may have a weighted score total of three hundred thirty six (336) that is calculated by summing the weighted score of each behavioral trait. Although a particular technique for weighting behavioral traits is provided, one or more other techniques may be utilized to weight behavioral traits and the particular weights utilized may be modified with respect to one another, as desired.

Illustratively, the one or more behavioral traits may be selected, ordered, ranked, weighted, and/or have an intensity level applied thereto based on algorithms of the matching system 10 that determine (e.g., at least initially) the behavioral traits of a desirable or ideal job seeker 12 for the job opening based on the information received from the employer 14 when the employer 14 creates a new job posting. Such algorithms may be created based, at least in part, on industry insight acquired by the matching system 10 and/or administers 11 of the matching system 10, along with, in some cases, feedback on successful and/or unsuccessful matches.

In some cases, the algorithms may be learning algorithms and/or non-learning algorithms. Learning algorithms may be algorithms that adjust over time and/or algorithms that may form a neural network or other network to continually improve the algorithms used to apply or associate behavioral traits to job postings and/or make matches between job seekers 12 and job postings. Illustratively, the algorithms may learn from proposed matches between job seekers 12 and job postings that are accepted and/or rejected, and/or from acceptance, changes in, and/or reordering by employers of lists of behavioral traits applied to or associated with a job posting. The algorithms may, additionally or alternatively, learn from (e.g., by observing) the communications between a job seeker 12 and an employer 14 of a matched job posting.

In one example of associating attributes with a created job posting with the matching system 10, one or more pieces of demographic information and five behavioral traits may be associated to a job posting to create the initial job posting profile 22. The five behavioral traits may be given an intensity level and/or may be ordered, ranked, or weighted in the initial job posting profile 22 according to an order of desirability, importance, or relevance with respect to the job posting, as determined by the matching system 10. Alternatively, the five behavioral traits may not be given an intensity level and/or may not be ordered, ranked, or weighted.

In some cases, the matching system 10 may associate one or more attributes to a new job posting in real time (e.g., with or without an intensity level, an order, a ranking and/or a weighting). For example, as an employer 14 creates 110 or enters a new job posting in the matching system 10 (e.g., as the employer 14 is selecting or entering options related to creating the new job posting) through the employer user interface 20c, the matching system 10 may provide to the employer user interface 20c, and/or to one or more other locations, one or more behavioral traits or other attributes, and intensity level of those one or more behavioral traits or other attributes, and/or an order of those one or more behavioral traits or other attributes it is associating with (e.g., applying to or suggesting for) the new job posting in the initial job posting profile 22. Additionally, or alternatively, one or more other features disclosed herein may be provided in real time to facilitate instantaneous or near instantaneous feedback to one or more users of the matching system 10.

After the attributes have been applied to the job posting profile to create 110 the initial job posting profile 22, the initial job posting profile 22 may be provided to the employer 14 for review. The initial job posting profile 22 may be provided to the employer 14 in one or more manners, for example, through the employer user interface 20c, via email, and/or through other methods or techniques. During the review of the initial job posting profile 22, the employer 14 may be able to approve and/or modify the one or more attributes in the initial job posting profile 22, an intensity level of the one or more attributes, an order, ranking, or weighting of the one or more attributes, and/or one or more other features of the initial job posting profile 22. In one example, the employer 14 may be able to modify one or more pieces of the demographic information associated with the job posting, which behavioral traits are associated with the job posting, the intensity level of the behavioral traits associated with the job posting, the order of importance of the behavioral traits associated with the job posting, the weighting of the behavioral traits associated with the job posting, the number of behavioral traits associated with the job posting, and/or the employer 14 may be able to make other modifications to the initial job posting profile during the employer review.

It is noted that by modifying a list of behavioral traits associated with a job posting, an employer 14 may introduce its own bias to the process of identifying a desirable job seeker. Even so, an employer 14 may choose to make such modifications (e.g., despite the introduction of bias) to further facilitate finding a desirable job seeker 12. In some cases, an employer 14 may make such a modification, for example, based on a known quality it appreciates in employees that have previously filled positions similar to the position of the job posting. The matching system 10 may alert the employer 14 through the employer user interface 20c, or through on or more other manners, of the potential for bias when it modifies or proposes modifying a listing of behavioral traits applied to or associated with the job posting.

Once the employer 14 has reviewed and made changes, if any, to the attributes associated with the job posting, the employer 14 may submit its review of the initial job posting profile 22 to the matching system 10 through the employer user interface 20c. The matching system 10 may process 120 the review of the initial job posting profile 22 by the employer 14. The processing 120 of the review of the initial job posting profile 22 by the employer 14 may include saving changes to the initial job posting profile 22 made by the employer 14.

In some instances, the processing 120 of the review of the initial job posting profile 22 by the employer 14 may include the matching system 10 providing instantaneous or delayed feedback to the employer 14 in response to changes or proposed changes by the employer 14 to the initial job posting profile 22. In one example, the matching system 10 may provide example job seeker profiles 26 that the matching system 10 may match with the modified initial job posting profile 22 to help an employer 14 understand whether it is actually desirable to make a change or proposed change to the initial job posting profile 22.

From the review of the initial job posting profile 22, the matching system 10 may create the final job posting profile 24 in view of the processed review of the initial job posting profile 22 by the employer 14. The final job posting profile 24 may include the one or more attributes (e.g., demographic information and one or more behavioral traits) of a desirable job seeker 12 to fill the position of the job posting of the modified or accepted initial job posting profile 22. The final job posting profile 24 may be saved in a job posting profile database in the memory 18 such that the matching system 10 may look for desirable job seekers 12 to fill the position of the subject job posting for the final job posting profile 24.

The matching system 10 may be configured to match job seeker profiles 26 to the final job posting profile 24 and job seeker profiles 26 may be created 150 in or through the matching system 10 and stored in a job seeker database of the matching system 10. In some instances, before a job seeker 12 is allowed to search for job postings in the matching system 10 and/or interact with an employer 14 through the matching system 10, the job seeker 12 may be required to setup a job seeker profile 26.

Job seeker profiles 26 may include one or more attributes of the associated job seeker 12. The one or more attributes may include demographic information (e.g., demographic preferences) of the job seeker 12 and/or behavioral trait information of the job seeker 12. The demographic information about the job seeker 12 may include, but is not limited to, age, salary requirements of the job seeker 12, ability and/or desire to travel, location of the job seeker 12, degree information, past job experience of the job seeker 12, and/or other demographic information related to the job seeker 12. The behavioral trait information may include job seeker 12 specific information as it relates to the following behavioral traits: adaptability, being amiable, ability to be assertive, ability to be charismatic, ability to be coached, ability to commit, ability to communicate, ability to compete, ability to be compliant, ability to be confident, ability to be creative, ability to be decisive, ability to delegate, ability to be deliberate, dependability, ability to be disciplined, ability to be driven, ability to be empathetic, ability to listen, ability to be independent, ability to be influential, ability to be inquisitive, integrity, ability to lead, ability to manage, ability to negotiate, ability to be optimistic, ability to organize, ability to be passionate, ability to be technical, ability to be a visionary, and/or other similar or dissimilar behavioral traits.

A job seeker profile 26 may be created by a job seeker 12 interacting with a job seeker user interface 20b of the matching system 10. In one example, a job seeker 12 may create an account and/or login to its account to initiate a job seeker profile.

The job seeker 12 may provide answers to questions and/or fill in fields to provide demographic information related to the job seeker's educational background, work experience, desires for future employment, and/or other demographic information. Illustrative demographic information related questions may include, but are not limited to, “How many years of experience do you have?”, “Do you have a college degree? If yes, what level?”, “What job types/roles are you experienced in and/or have a desire to pursue?”, “Do you desire a job in a particular industry? If so, which industry?”, “Are you willing to relocate?”, “What is your salary requirement?”, and/or other questions directly or indirectly relating to demographic information of the job seeker 12.

The demographic information associated to a job seeker profile 26 may be modified over time by the job seeker 12, as desired. Alternatively, the demographic information associated with the job seeker profile 26 may be permanently associated with a job seeker profile 26 or associated with the job seeker profile 26 for a set period of time before it can by modified by the job seeker 12.

Information related to behavioral traits of the job seeker 12 may be assigned to the job seeker's 12 job seeker profile 26 by the matching system 10. In one illustrative example, the job seeker user interface 20b may present the job seeker 12 with one or more questions from a psychometric test or other test designed to (e.g., indirectly, directly, or indirectly and directly) determine the extent to which a job seeker has one or more behavioral traits. Alternatively, or in addition, the questions from the psychometric test maybe administered to the job seeker 12 through a testing site or through other manners. The matching system 10 may then receive answers to the question through the job seeker user interface 20b or through other means (e.g., from a testing site administering the psychometric test).

In some instances, the psychometric test may include one or more questions that are designed to indirectly determine the extent to which the job seeker has one or more behavioral traits. One of the goals of the psychometric test, among others, may be to determine what behavioral traits a job seeker 12 may possess without bias from the job seeker 12 or influence other than how the psychometric test was developed.

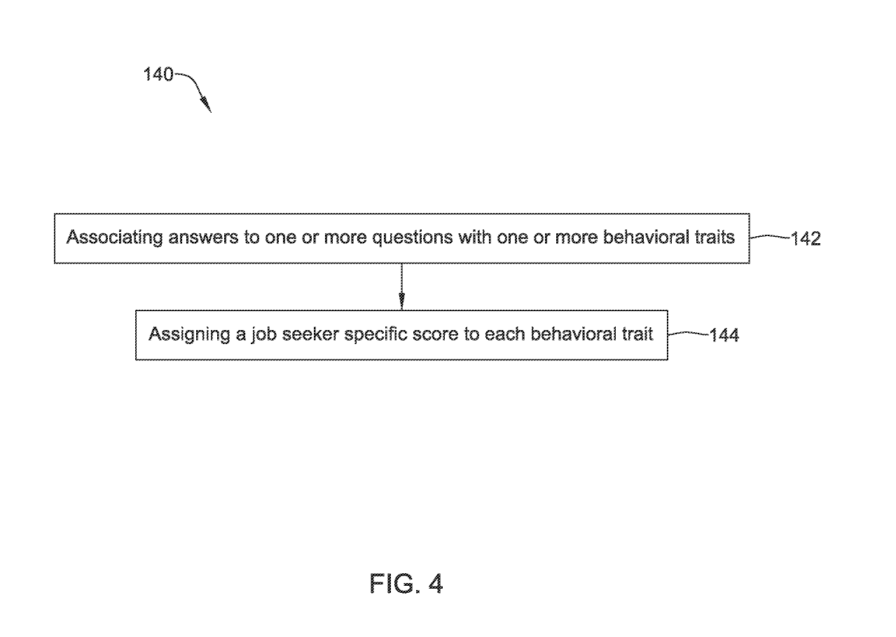

Once answers (e.g., responses) to the one or more survey questions of a psychometric test relating directly, indirectly, or indirectly and directly to the one or more attributes of the job seeker 12 (e.g., demographic information and/or behavioral traits) are received by the matching system 10, the answers may be processed 140. As shown in the schematic flow diagram of FIG. 4, processing of the answers may include, but is not limited to, associating 142 the answers to the one or more questions of the psychometric test to the one or more behavioral traits. Then, based on rules of the psychometric test, assigning 144 a job seeker 12 a specific score to each tested-for behavioral trait of the job seeker 12.

Alternatively, or in addition, to scoring each tested-for behavioral trait, the answers to each question of the psychometric test may be saved to the job seeker profile 26. In such cases, the answers may be compared to attributes of a desirable job seeker that may be associated with or applied to a final job posting profile 24 and a job seeker behavioral trait score (e.g., a trait score) may be determined for the job seeker 12 with respect to each final job posting profile 24, as described further below.

In some instances, the job seeker 12 may be allowed to take the psychometric test only a single time. As such, the job seeker's 12 specific score for each tested-for behavioral trait and/or question will always remain the same. Alternatively, the job seeker 12 may be allowed to retake the psychometric test after a period of time and/or after meeting a threshold (e.g., after achieving a specific training or meeting a different threshold). Setting a limit on the frequency at which a job seeker may take the psychometric test may limit the ability of the job seeker to game or trick the matching system 10 into providing a score for one or more behavioral traits that is not reflective of the job seeker's 12 actual behavioral trait set.

As an alternative to limiting the frequency at which a job seeker 12 may take the psychometric test, a job seeker 12 may take the psychometric test as frequently as desired. In such situations, the scoring by the matching system 10 of the answers to the psychometric test may be configured to address a job seeker 12 that is attempting to game or trick the matching system 10. For example, the matching system 10 may be configured to average scores for behavioral traits from answers to a plurality of psychometric tests that were taken within a set time period (e.g., within one day, within one week, within one month, within one year, within five years, and so on).

From the processed answers to the one or more survey questions of the psychometric test, a job seeker profile 26 may be created 150 for the job seeker 12. The job seeker profile 26 may include one or more attributes of the job seeker 12, which may include demographic information about the job seeker 12 and/or information related to behavioral trait sets of the job seeker 12 (e.g., scores for each tested behavioral trait, scores for a sub-set of the tested-for behavioral traits (e.g., a number of the job seeker's 12 strongest behavioral traits), and/or scores for test question answers). Although the demographic information of the job seeker 12 may be modified by the job seeker 12 over time, the behavioral traits may be determined by the matching system 10 such that the job seeker 12 may not be provided with an ability to modify the information in its job seeker profile 26 related to its behavioral traits. The created job seeker profile 26 may then be saved in a job seeker database in the memory 18.

The matching system 10 may compare 160 one or more job seeker profiles 26 from the job seeker profile database in the memory 18 to one or more final job posting profiles 24 from the job posting profile database in the memory 18 to create a list of top job seekers 12 for a final job posting profile and/or create a list of top job posting prospects for a job seeker 12. The created list of top job seekers 12 for a final job posting profile 24 may be accessed through the employer user interface 20c and/or through other notification from the matching system 10. The created list of top job posting prospects for job seeker 12 may be accessed through the job seeker user interface 20b and/or through other notification from the matching system 10.

Comparing 160 one or more job seeker profiles 26 to one or more final job posting profiles 24 may include one or more evaluation steps and/or score computation steps or features. In one example comparing 160 technique of the matching system 10 effected through the execution of instructions in the memory 18 by the processor 16, as shown in the schematic flow diagram of FIG. 5, the comparing may start by selecting 162 a job seeker profile 26 and a final job posting profile 24 and then performing a demographic comparison 165 (e.g., comparing demographic ideals associated with a final job posting profile 24 and demographic preferences of a job seeker profile 26) and/or a behavioral trait comparison 171. The demographic comparison 165 may include performing an “ignore list” evaluation 164, an industry specific evaluation 166, an education level evaluation 168, a salary range evaluation 170, a work experience evaluation 172, a willingness to travel evaluation 174, a prior work history evaluation 176, a geographic match evaluation 178, and/or other demographic related evaluations. The evaluations of the demographic comparisons 165 may be performed in one or more orders and failure of a threshold amount (one, two, three, half, a quarter, and/or other threshold amount) of the demographic evaluations may result in no match being created 186 between the job seeker profile 26 and the final job posting profile 24. The behavioral trait comparison 171 may be performed if the job seeker profile 26 and the final job posting profile 24 pass the demographic information comparison 165 and/or if the demographic comparison 165 has not been performed or has not been passed. The behavioral trait comparison 171 may include calculating 180 a match score and comparing 182 the match score to a threshold minimum match score. If the job seeker profile 26 and the final job posting profile 24 pass the demographic information comparison 165 and the behavioral trait comparison 171, a match is created 184. If the job seeker profile 26 and the final job posting profile 24 do not pass one or more of the demographic information comparison and behavioral trait comparison 171, no match is created 186. This description is an illustrative example of a comparing evaluation 160 and the comparing evaluations 160 may be modified (e.g., to add one or more evaluation, to omit one or more evaluation, and/or to perform one or more evaluation in one or more other orders), as desired.

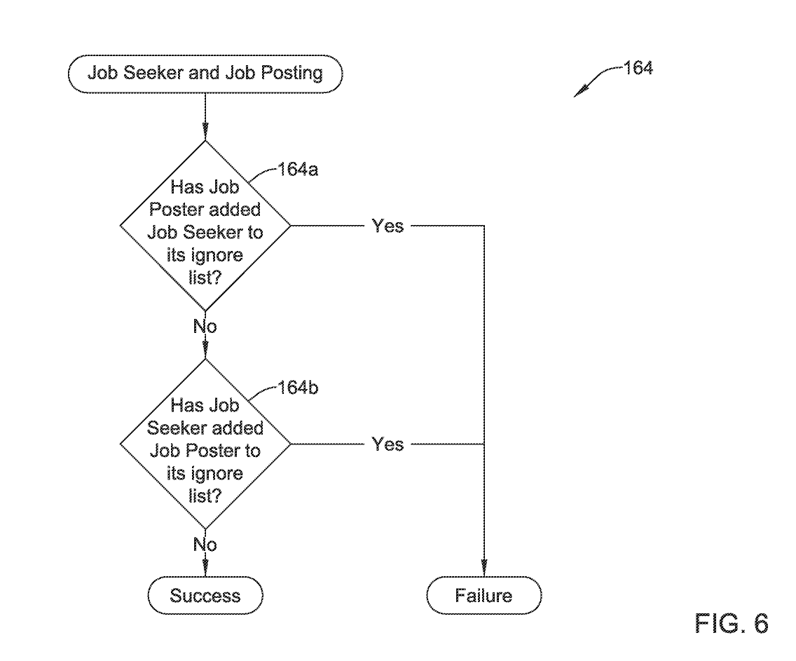

FIG. 6 is a schematic flow diagram of an ignore list evaluation 164 that may be performed by matching system 10 through comparing the job seeker profile 26 and the final job posting profile 24 to respective “ignore lists” of the job seeker 12 and/or an employer 14. Ignore lists may be lists that either the job seeker 12 and/or an employer 14 create in their demographic information to instruct the matching system 10 to exclude certain job seekers, certain employers and/or certain types of job seekers and employers from creating a matching with their profile 24, 26. In the example shown in FIG. 6, the matching system 10 may ask and/or determine 164a whether the employer 14 has added the job seeker 12 to its ignore list and the matching system 10 may ask and/or determine 164b whether the job seeker 12 has added the employer 14 to its ignore list. If the employer 14 has added the job seeker 12 to its “ignore list” and/or the job seeker 12 has added the employer 14 to its “ignore list”, the matching system 10 may determine the “ignore list” evaluation 164 has been a failure for the match. If neither the job seeker 12 nor the employer 14 added the other to its respective “ignore list”, the matching system 10 may determine the ignore list evaluation 164 has been a success. This description is an illustrative example of an ignore list evaluation 164 and the ignore list evaluations 164 may be modified, as desired.

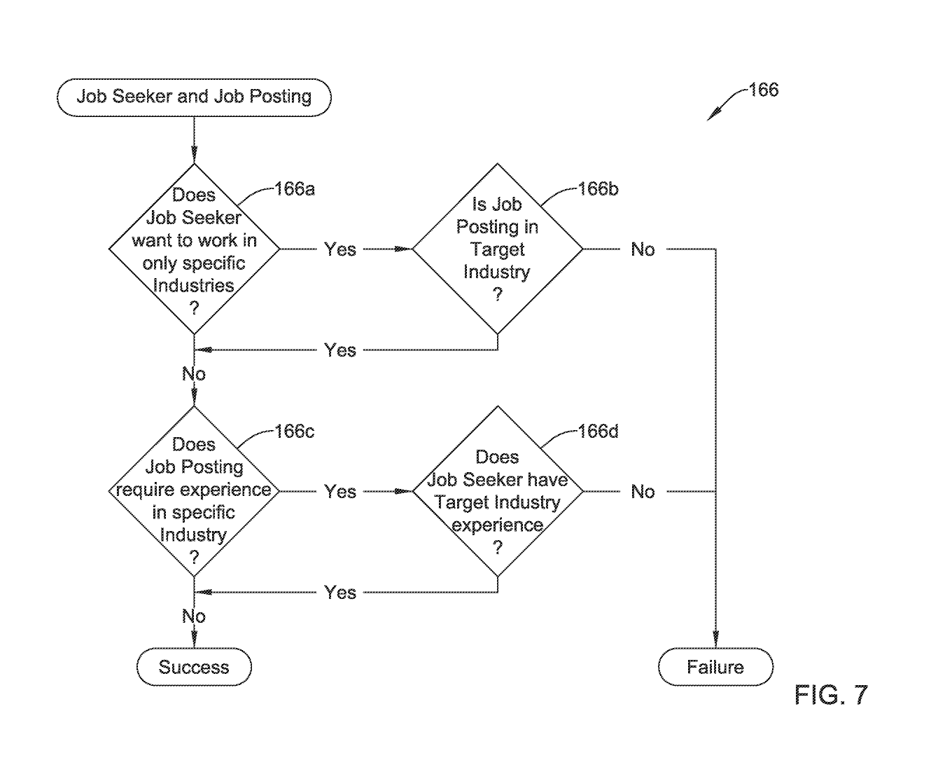

FIG. 7 is a schematic flow diagram of an industry specific evaluation 166 that may be performed by the matching system 10 through determining whether the job seeker profile 26 indicates the job seeker 12 wants to work in only one or more specific industries (e.g., car sales, retail sales, legal, accounting, etc.) 166a and whether the final job posting profile 24 requires experience in one or more specific industries 166c. If the job seeker profile 26 indicates the job seeker 12 wants to work in a specific industry or industries and the matching system 10 determines 166b the job posting of the final job posting profile 24 is in an industry other than the specified industry or industries, the matching system 10 may determine the industry specific evaluation 166 is a failure. If the final job posting profile 24 requires experience in one or more specific industries and the matching system determines 166d that the job seeker profile 26 indicates the job seeker 12 does not have experience in the one or more specific industries, the matching system 10 may determine the industry specific evaluation 166 is a failure. If the job seeker profile 26 does not require a job specific industry or the matching system 10 determines 166b the job posting of the final job posting profile 24 is in the industry or industries specified in the job seeker profile 26 and the final job posting profile 24 either does not require experience in a specific industry or the matching system 10 determines 166d the job seeker 12 has experience in one or more of the one or more industries specified in the final job posting profile 24, the matching system 10 may determine the industry specific evaluation is a success. This description is an illustrative example of an industry specific evaluation 166 and the industry specific evaluations 166 may be modified, as desired.

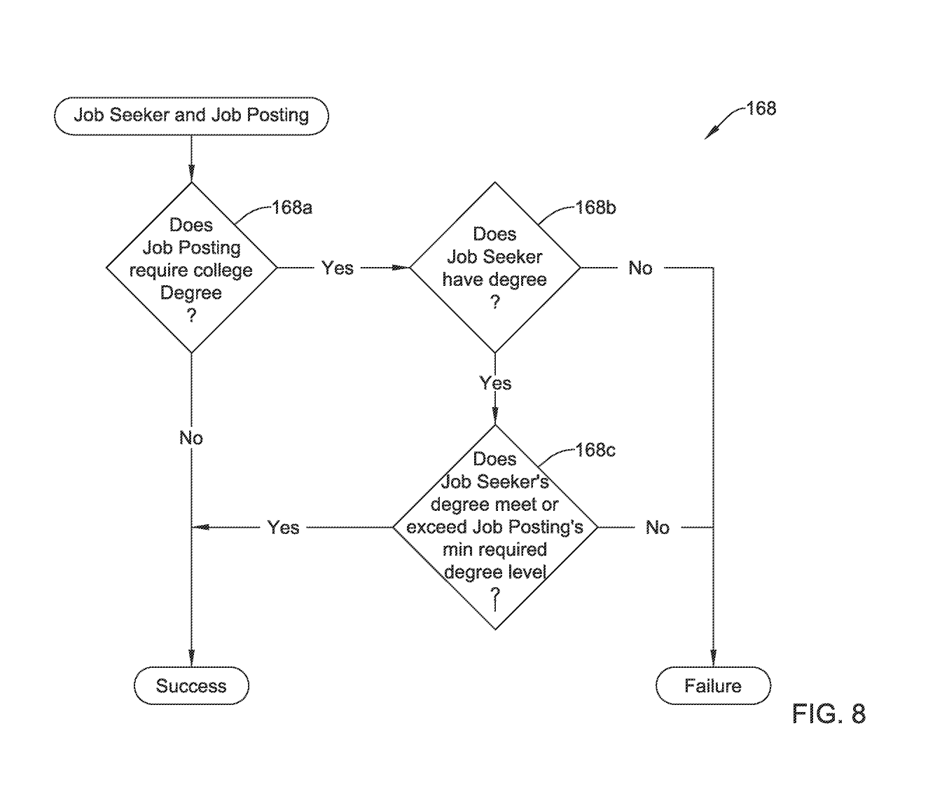

FIG. 8 is a schematic flow diagram of an education level evaluation 168 that may be performed by the matching system 10 through determining 168a whether the final job posting profile 24 requires a particular college degree 168a, determining 168b whether the job seeker profile 26 indicates the job seeker 12 has a college degree, and determining 168c whether the job seeker's 12 degree meets and/or exceeds the degree required in the final job posting profile 24. If the matching system 10 determines 168a that the final job posting requires a level of college degree and the matching system 10 determines 168b that the job seeker profile 26 indicates the job seeker 12 does not have a college degree or determines 168c that the job seeker profile 26 indicates the job seeker 12 does not have the level of degree required in the final job posting profile 24, the matching system 10 may determine the education level evaluation 168 is a failure. If the matching system 10 determines 168a the final job posting profile 24 does not have a college degree level requirement or the matching system 10 determines 168a that the final job posting profile 24 does require a minimum level of college degree, determines 168b that the job seeker profile 26 indicates the job seeker 12 has a college degree, and determines 168c that the job seeker profile 26 indicates the job seeker 12 has the required level of college degree, the matching system 10 may determine the education level evaluation 168 is a success. This description is an illustrative example of an education level evaluation 168 and the education level evaluations 168 may be modified, as desired.

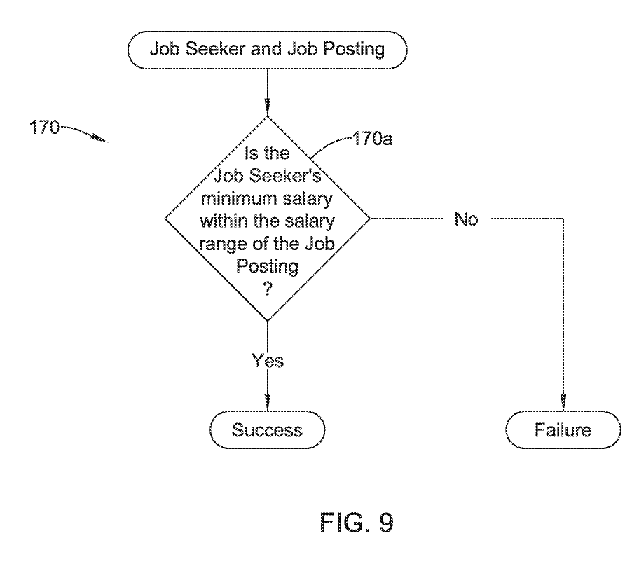

FIG. 9 is a schematic flow diagram of a salary range evaluation 170 that may be performed by the matching system 10 through determining 170a whether a minimum salary requirement in the job seeker profile 26 is within a salary range of the specific final job posting profile 24. If the matching system 10 determines the minimum salary requirement in the job seeker profile 26 is not within the salary range associated with the specific final job posting profile 24, the matching system 10 may determine the salary range evaluation 170 is a failure. If the matching system 10 determines the minimum salary requirement in the job seeker profile 26 is within the salary range associated with the specific final job posting profile 24, the matching system 10 may determine the salary range evaluation is a success. Note, if the matching system 10 determines the job seeker profile 26 does not include a minimum salary requirement and/or determines the specific final job posting profile 24 does not include a salary range, the matching system 10 may determine the salary range evaluation 170 is a success. This description is an illustrative example of a salary range evaluation 170 and the salary range evaluations 170 may be modified, as desired.

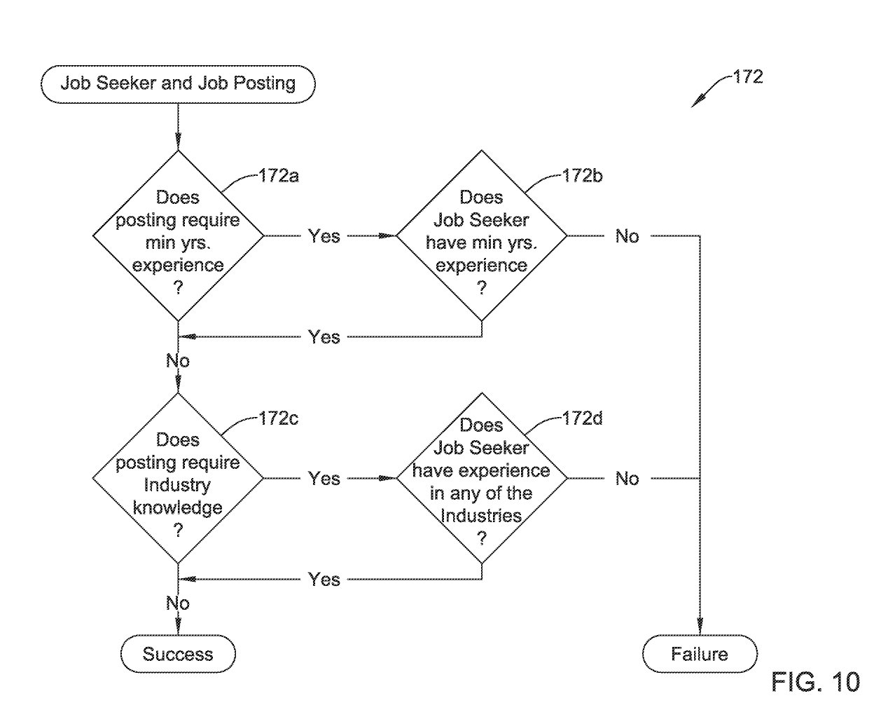

FIG. 10 is a schematic flow diagram of a work experience evaluation 172 that may be performed by the matching system 10 through establishing 172a whether a final job posting profile 24 has a minimum years of experience requirement. If the final job posting profile 24 does include a minimum years of experience requirement, the matching system 10 may determine 172b whether the job seeker 12 meets the minimum years of experience requirement. If the job seeker 12 does not meet the minimum years of experience requirement, the matching system 10 may determine the work experience match evaluation 172 is failed. If there is no minimum years of experience requirement or the job seeker 12 meets the minimum years of work experience requirement, the matching system 10 may determine 172c whether the final job posting profile 24 includes an industry knowledge requirement. If the final job posting profile 24 does include an industry knowledge requirement, the matching system 10 may determine 172d whether the job seeker meets the industry knowledge requirement of the final job posting profile 24. If the job seeker 12 does not meet the industry knowledge requirement, the matching system 10 may determine the work experience match evaluation 172 is failed. If there is no industry knowledge requirement or the job seeker 12 meets the minimum years of work experience requirement, the matching system 10 may determine the work experience match evaluation 172 is a success. This description is an illustrative example of a work experience evaluation 172 and the work experience evaluations 172 may be modified, as desired.

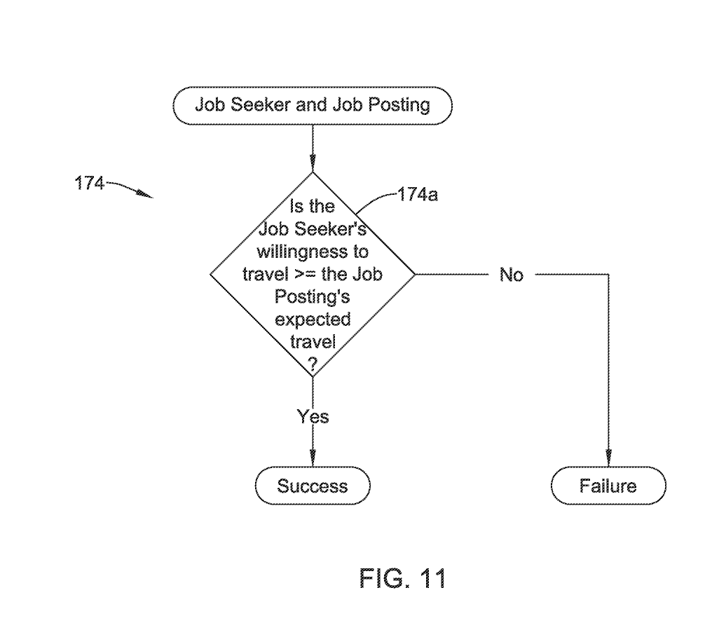

FIG. 11 is a schematic flow diagram of a willingness to travel evaluation 174 that may be performed by the matching system 10 through determining 174a whether a willingness to travel for work amount as represented in the job seeker profile 26 is within an expected travel for work amount of the specific final job posting profile 24. If the matching system 10 determines the willingness to travel for work amount represented in the job seeker profile 26 is not within an expected travel for work amount of the specific final job posting profile 24, the matching system 10 may determine the willingness to travel evaluation 174 is a failure. If the matching system 10 determines the willingness to travel for work amount in the job seeker profile 26 is within the expected travel for work amount associated with the specific final job posting profile 24, the matching system 10 may determine the salary range evaluation is a success. Note, if the matching system 10 determines the job seeker profile 26 does not include a willingness to travel for work amount and/or determines the specific final job posting profile 24 does not include an expected travel for work amount, the matching system 10 may determine the willingness to travel evaluation 174 is a success. This description is an illustrative example of a willingness to travel evaluation 174 and the willingness to travel evaluations 174 may be modified, as desired.

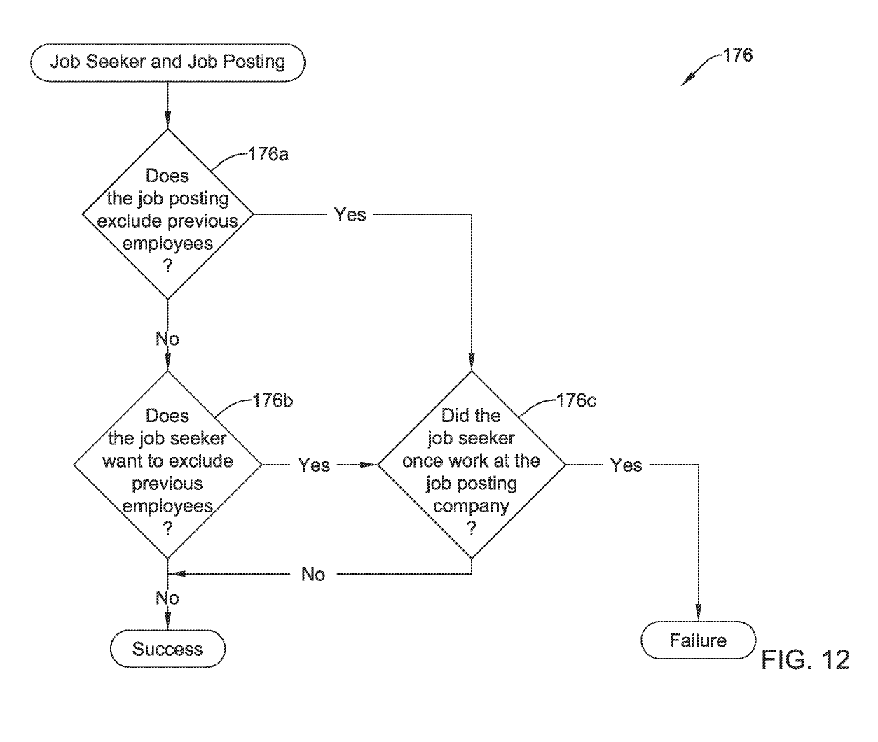

FIG. 12 is a schematic flow diagram of a prior work history evaluation 176 that may be performed by the matching system 10 through determining 176a whether the final job posting profile 24 excludes pervious employees and/or determining 176b whether the job seeker profile 26 excludes previous employers. If the final job posting profile 24 does exclude previous employees and/or the job seeker profile 26 does exclude previous employers, the matching system 10 may determine 176c whether the job seeker profile 26 indicates the associated job seeker 12 is a former employee of the employer 14 associated with the final job posting profile 24. If the job seeker 12 is a former employee of the employer and one or more of the final job posting profiles 24 and the job seeker profile 26 exclude former employees/employers from its matches, the matching system 10 may determine the prior work history match evaluation 176 is a failure. If the job seeker is not a former employee of the employer and/or neither of the final job posting profile 24 nor the job seeker profile 26 exclude former employees/employers, the matching system 10 may determine the prior work history match evaluation 176 is a success. This description is an illustrative example of a prior work history evaluation 176 and the prior work history evaluations 176 may be modified, as desired.

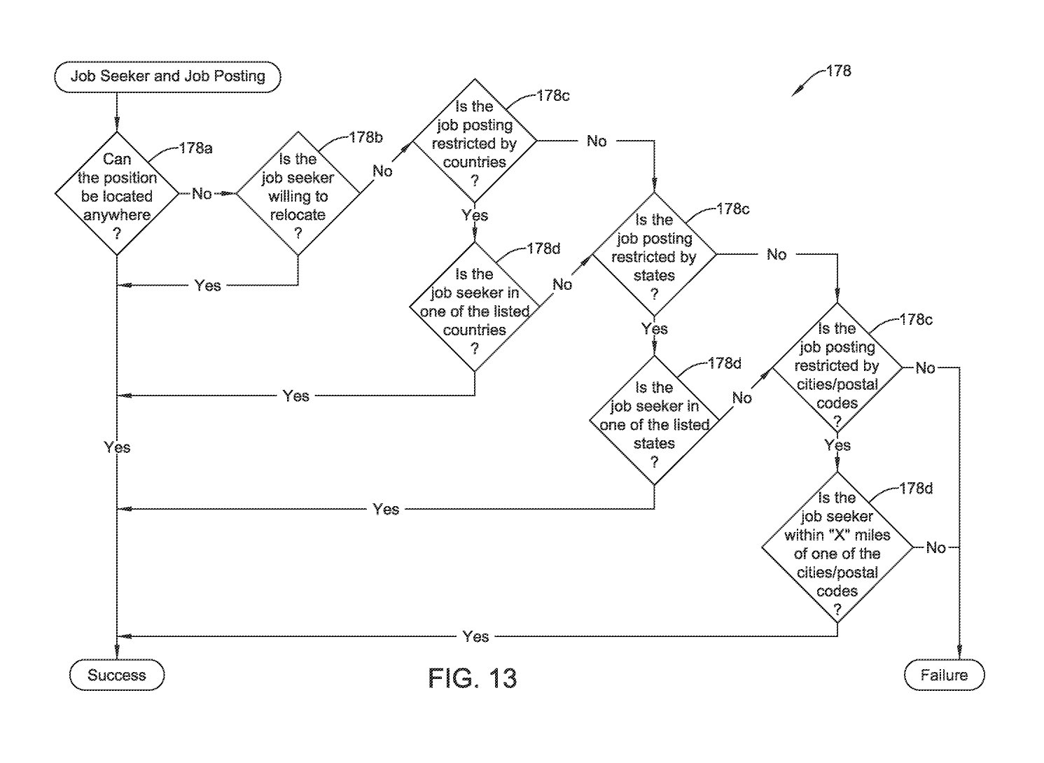

FIG. 13 is a schematic flow diagram of a geographic match evaluation 178 that may be performed by the matching system 10 through determining 178a whether the job posting of the final job posting profile 24 allows for a desirable job seeker 12 to be located geographically anywhere. If the position of the final job posting profile 24 is at a specific geographic location, the matching system 10 may determine 178b whether the job seeker 12 of the job seeker profile 26 is willing to relocate for a job. If the job seeker profile 26 does not allow for relocation of the job seeker 12, the matching system 10 may determine 178c if the final job posting profile 24 requires a desirable job seeker to be in a specific country, a specific state, a specific city or postal code, and/or to be in some other specific geographic location. Then, the matching system 10 may determine 178d whether the job seeker 12 of the job seeker profile 26 located in one of the listed countries, states, cities or postal codes and/or other specific geographic location. If the job seeker 12 of the job seeker profile 26 is unwilling to relocate and does not meet all of the geographic location requirements 178c of the final job posting profile 24, the matching system 10 may determine the geographic match evaluation 178 is a failure. If the job seeker 12 of the job seeker profile 26 meets all of geographic restriction requirements of a final job posting profile, the job seeker 12 of the job seeker profile 26 is willing to relocate to location specific area of the final job posting profile 24, and/or a desirable job seeker 12 for the final job posting profile 24 can be located geographically anywhere to perform the job of the final job posting profile 24, the matching system 10 may determine the geographic match evaluation 178 is a success. This description is an illustrative example of a geographic match evaluation 178 and the geographic match evaluations 178 may be modified, as desired.

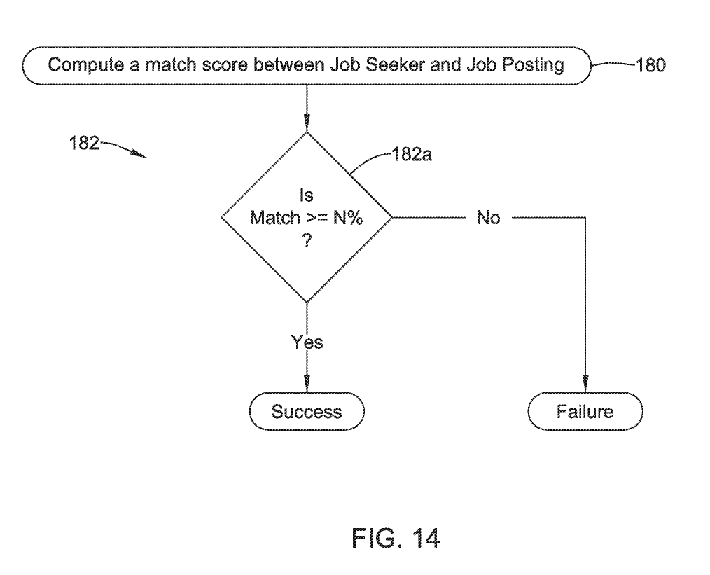

FIG. 14 is a schematic flow diagram of a minimum match score evaluation 182 that may, in some cases, be performed by the matching system 10 through determining 180 a weighted match score for the job seeker profile 26 with respect to the specific final job posting profile 24 and determining 182a if the weighted match score meets a minimum weighted match score requirement in the matching system 10 and/or the final job posting profile 24. Minimum weighted match score requirements may act as quality control measures, as it may not be desirable for the matching system 10 to provide low quality matches even if the low quality match is the best match available. If the weighted match score is below a minimum weighted match score requirement (e.g., the weighted match score is less than N % of the total weight score), the matching system 10 may determine the minimum match score evaluation 182 is a failure. If the weighted match score is at or above a minimum weighted match score requirement (e.g., the weighted match score is at or above N % of the total weight score), the matching system 10 may determine the minimum match score evaluation 182 is a success. This description is an illustrative example of a minimum match score evaluation 182 and the minimum match score evaluations 182 may be modified, as desired.

A weighted match score between a job seeker profile 26 and a final job posting profile 24 may be calculated in one or more manners. In one example, the weighted match score may relate to a behavioral trait match between the job seeker profile 26 and the final job posting profile 24. As discussed above, each final job posting profile 24 may have a particular number of weighted or ranked behavioral traits associated therewith and a job seeker profile 26 may include one or more scored behavioral traits. From the ranked behavioral traits associated with the final job posting profile 24 and the scored behavioral traits of the job seeker profile 26, a weighted match score may be calculated for a job seeker profile 26. The following chart depicts a weighted trait score calculation, where each behavioral trait associated with the job posting is weighted twenty percent less than the more important behavioral trait above it:

CHART 1

| Trait Associated | | | Job Seeker |
|---|---|---|---|
| with the Job | | Job Seeker Trait | Weighted Trait |
| Posting | Weight | Score | Score |
| Driven | 100 | 87 | (100/100) * 87 = 87 |
| Competitive | 80 | 87 | (80/100) * 87 = 70 |
| Self-Starter | 64 | 85 | (64/100) * 85 = 54 |
| Assertive | 51 | 81 | (51/100) * 81 = 41 |
| Friendly | 41 | 88 | (41/100) * 88 = 36 |
| Total Weighted | 336 | Total Weighted | 288 |
| Score (sum of the | | Match Score (sum | |
| weights): | | of the weighted | |
| | | trait scores): | |

From the above chart, the total weight score for the five traits applied to the final job posting profile 24 is 336. The total weighted match score for the job seeker profile 26 with respect to the final job posting profile 24 is 288. As a result, the percent match between the job seeker profile 26 and the final job posting profile 24 is an 86% match (288/336=86%). Thus, if a minimum weighted match score is fifty percent (50%) of the total weight score for the five traits of the final job posting profile 24 (e.g., 118), the total weighted score for the job seeker profile 26 meets the minimum weighted score requirement (e.g., a total weighted score of 288 is above a minimum weighted score requirement of 118) and there is a successful match between the job seeker profile 26 and the final job posting profile 24.

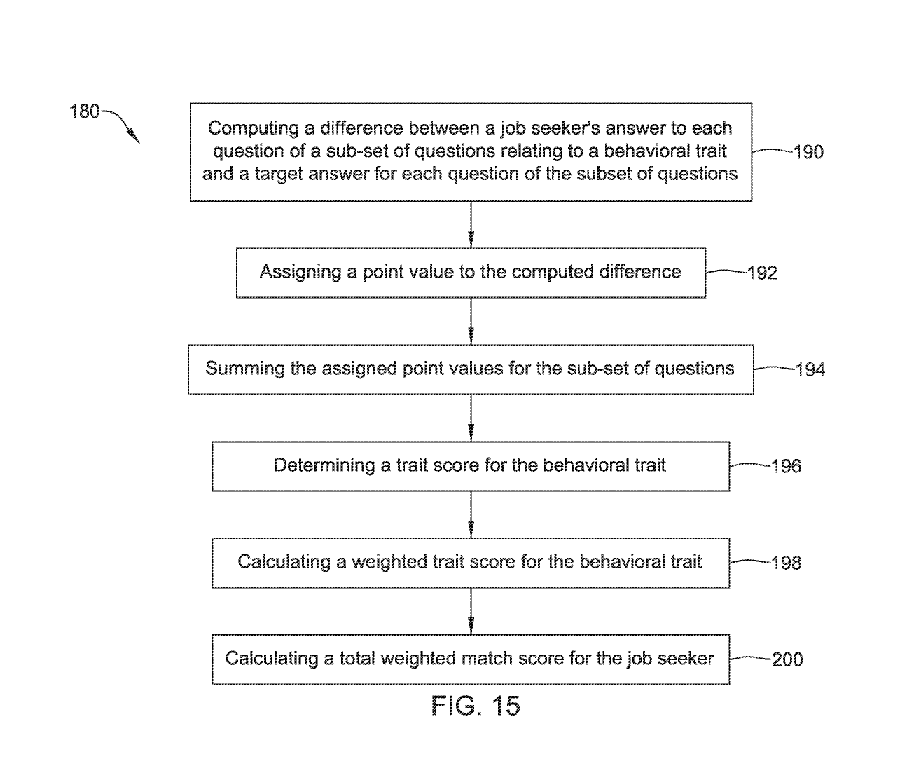

Additionally, or alternatively, calculating 180 a match score (e.g., a total weighted match score or other match score) between a job seeker profile 26 and a final job posting profile 24, as shown in FIG. 15, may take into consideration how strongly a job seeker 12 is determined to exhibit each of the behavioral traits associated with the final job posting profile 24 or other characteristic related to those behavioral traits, based at least in part on answers or responses to the psychometric test or other test. Such consideration may include determining how well an intensity level of a specific behavioral trait exhibited by a job seeker 12 matches a desired intensity level of the specific behavioral trait in a final job posting profile 24. How well an intensity level of a specific behavioral trait exhibited by a job seeker 12 matches a desired intensity level of the specific behavioral trait in a final job posting profile 24 may be determined by comparing the job seeker's 12 answers to questions on a psychometric test or other test relating to the specific behavioral trait to expected answers to those questions for the specific behavioral trait, where the expected answers are determined from the desired intensity level associated with the specific behavioral trait in the final job posting profile 24. Alternatively, or in addition, how well an intensity level of a specific behavioral trait exhibited by a job seeker 12 matches a desired intensity level of the specific behavioral trait in a final job posting profile 24 may be determined in one or more other manners.

In calculating 180 a match score, as shown in FIG. 15, an intensity level of a specific behavioral trait exhibited by a job seeker 12 may be compared to an intensity level for the specific behavioral trait in the final job posting 24 by computing 190 a difference (e.g., a variance) between a job seeker's 12 answer to each question of the psychometric test that is testing for the specific behavioral trait (e.g., answers to questions of a sub-set of questions, where the sub-set of questions is testing for the specific behavioral trait) and the desired or target answers for those questions based on the desired intensity level associated with that specific behavioral trait. For each of the differences computed for the questions related to a specific behavioral trait, a point value (e.g., a numerical value or other value) may be assigned 192 to that computed difference.

In some cases, the point value assigned 192 may be based upon a linear or non-linear relationship with increasing differences (e.g., differences of 0, 1, 2, 3, 4, 5, and so on). In one example, the point value may be based upon a non-linear relationship with increasing computed differences such that the further the job seeker's 12 answers to questions measuring the specific behavioral trait are from the desired or target answer, the lower the assigned point value is.

Once all of the job seeker's 12 answers to questions of a sub-set of questions measuring a particular behavioral trait have been assigned point values, the point values may be summed 194. Then, a trait score may be calculated 196 using the sum of the assigned point values. In one example, the sum of the assigned point values may be divided by a sum of the total possible point value for each question of the sub-set of questions measuring the particular behavioral trait to calculate 196 a trait score for the job seeker 12. In some cases, a trait score may be a value between 0 and 1 and in other cases, the calculated value may be multiplied by 100 to obtain a percent match of intensity levels for the specific behavioral trait, which may also be considered a trait score. The trait score may be an indication of, among other things, how well a particular job seeker's 12 intensity level for a behavioral trait compares to the intensity level associated with the behavioral trait in the final job posting profile 24.

A trait score, taking or not taking into account intensity levels or other characteristics related to behavioral traits, for the job seeker 12 may be calculated for each behavioral trait associated with a final job posting 24. The trait score for each behavioral trait may be weighted 198 by a weight of the behavioral trait (as shown, for example, in Chart 1 above) to calculate a weighted trait score. In some cases, the trait scores for a job seeker 12 may be weighted in one or more other manners. A total weighted match score for a job seeker 12 with respect to a final job posting profile 24 may then be calculated 200 from the weighted trait scores. In one example, the weighted trait scores may be summed to calculate 200 a total weighted match score for the job seeker 12 with respect to the final job posting profile 24.

In some instances, a percent match between the job seeker profile 26 and the final job posting profile 24 may be determined based, at least in part, on the weighted match score. Illustratively, a percent match may be calculated by dividing the weighted match score by the sum of the weights of the behavioral traits of the final job posting profile 24 (e.g., by a total weighted score of the behavioral traits). Alternatively, or in addition, a percent match between the job seeker profile 26 and the final job posting profile 24 be determined in one or more other manners.

In one illustrative example of measuring an intensity level exhibited by a job seeker 12, each question of a psychometric test or other test taken by the job seeker 12 may have five possible answers, where each answer may be associated with a different intensity level for a specific behavioral trait. Alternatively, in some instances, not all intensity levels may be represented in the answers for the question and/or, in some cases, two or more answers may be associated with the same intensity level.

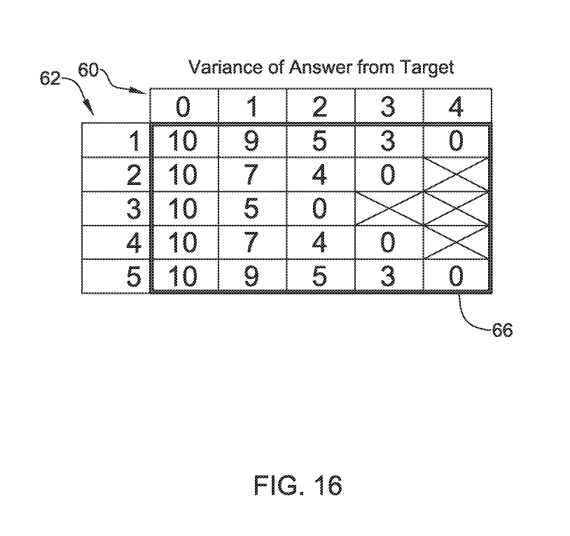

In the illustrative example, a desired intensity level of low may have a target or expected answer of 1 for all questions testing for a specific trait, a desired intensity level of low medium may have a target or expected answer of 2 for all questions testing for a specific trait, a desired intensity level of medium may have a target or expected answer of 3 for all questions testing for a specific trait, a desired intensity level of medium high may have a target or expected answer of 4 for all questions testing for a specific trait, and a desired intensity level of high may have a target or expected answer of 5 for all questions testing for a specific trait. Alternatively, a desired or target answer may not line up with a desired intensity level (e.g., a low intensity level does not necessarily line up with a desired or target answer of 1), but rather a particular desired intensity level for a specific behavioral trait may be associated with a set of answers to a sub-set of questions testing for the specific behavioral trait, where the set of answers may be different for one or more of the questions of the subset of questions (e.g., a target answer to question 1 may be 2, a target answer to question 2 may be 3, a target answer to question 3 may be 1, a target answer to question 4 may be 5, and a target answer to question 5 may be 3 for a desired intensity level of the specific trait). In some instances, the matching system 10 may use look-up tables or matrices, algorithms, or other mechanisms to determine desired or target answers to questions testing for a specific behavioral trait.

Where there are five answers for each question testing for the presence of the specific behavioral trait, there may be a maximum difference or variance of four (4) from a desired or target answer and a minimum difference of zero (0) for a question answered the same as the desired or target answer. An example variance-scoring matrix or look up table that may be used is shown in FIG. 16. The numbers in the cells of row 60 of the variance-score matrix of FIG. 16 depict the difference between an answer by the job seeker 12 and the desired or target answer to questions of the psychometric test or other test, where the desired or target answer may be based, at least in part, on an intensity level for the specific behavioral trait in a final job position profile 24. The numbers in the cells of column 62 of the variance-score matrix of FIG. 16 depict the target or expected answer based at least in part on a specified intensity level for the specific behavioral trait. The points or score (e.g., numerical value) assigned to each answer to a question of a sub-set of questions on the psychometric test or other test based on the difference of those answers from the target or expected answer are shown in the cells of rectangle 66 in the matrix of FIG. 16. In the example of FIG. 16, a numerical value of 10 is the largest possible numerical or point value for each answer to questions of a sub-set of questions related to a specific behavioral trait.

In an illustrative example of using a variance-score matrix similar to that of FIG. 16, where the points or score (e.g., numerical value) assigned to each answer are for an unspecified sample trait at an unspecified intensity level, six questions were presented to a job seeker 12, and the following chart was developed from the job seeker's answers to those questions:

CHART 2

| Column 1: | | | | |
|---|---|---|---|---|
| Question No. | | | | |
| of a sub-set of | | | | |
| questions of a | Column 2: | | Column 4: | |
| test, the sub-set | Expected/target | | Variance from | Column 5: |
| of question | answers for an | Column 3: | expected/targeted | Score (from the |
| related to the | intensity level | Job Seeker | answer (Absolute | variance- |
| specific | of a specified | Answers on a | value of Column | scoring matrix |
| behavioral trait | behavioral trait | scale from 1-5 | 3 minus Column 1 | of FIG. 16) |
| 1 | 5 | 1 | 4 | 0 |
| 2 | 3 | 1 | 2 | 0 |
| 3 | 5 | 2 | 3 | 3 |
| 4 | 4 | 2 | 2 | 4 |
| 5 | 5 | 2 | 3 | 3 |
| 6 | 3 | 5 | 2 | 0 |

Once the score is determined for each question from the variance-scoring matrix of FIG. 16, as shown in Chart 2, the trait score of the specific behavioral trait may be determined by summing the scores for each question from Column 5 of Chart 2, dividing by the total number of possible points (e.g., six question at a possible numerical value of 10 each equals 60 possible points), and multiplying by 100. From this, we have the following equation:

(Total score of 10(10=0+0+3+4+3+0))/(Total possible points of 60(60=six questions*ten points/question (see FIG. 16))*100=Trait Score of 16.67 (or 16.67%) (1)

As discussed, such an obtained Trait Score may be considered an indication of how well a job seeker's 12 intensity level for a particular behavioral trait matches an intensity level associated with a specific behavioral trait in a final job posting profile 24.

Utilizing trait scores calculated with variance-scoring matrices or other algorithms taking into account differences between an answer and an expected or targeted answer may allow the matching system 10 to identify how close a job seeker's 12 answers to questions are to answers expected or targeted for those questions as a result of a specified intensity level for a specified trait in a final job posting profile 24. For example, if the intensity level for a specified trait is medium and target answers to questions for the specified behavioral trait are three (3) on a scale of one (1) to five (5), the average trait score between a first job seeker that answers three (3) to all of the questions and a second job seeker that answers one (1) for half of the questions and five (5) for half of the questions maybe the same, three (3). However, as can be understood, the first job seeker may be more desirable for the job because the first job seeker answered all of the questions as desired for the specified behavioral trait, whereas the second job seeker was off by two from the desired answer for each of the questions asked for the specified behavioral trait. As a result, in some cases, an employer may look at a trait score separate from, as an alternative or in addition to, a weighted match score or percent match described above to determine a job seeker's fit for a job posting.

When trait Scores are determined for a job seeker 12 with respect to a particular final job posting profile 24 in view of intensity levels as in the manner discussed above, or in one or more other manners, the trait scores may be utilized as in Chart 1 as the Job Seeker Trait Score or as the scored behavioral traits. Then, from the ranked behavioral traits associated with the final job posting profile 24 and the corresponding scored behavioral traits of the job seeker profile 26, a weighted match score may be calculated for a job seeker profile 26 with respect to the final job posting profile 24 in the manner described above with respect to FIG. 15 and/or Chart 1.

In some cases, total weighted scores for a plurality of job seeker profiles 26 with respect to a final job posting profile 24 may be calculated by the matching system 10. The plurality of job seeker profiles 26 having total weighted scores for the final job posting profile 24 may be ranked according to the respective total weighted scores. A list of desirable job seekers 12 may then be provided to the employer 14 associated with the final job posting profile 24 by the matching system 10 through the employer user interface 20c or other mechanism.

In some cases, total weighted scores for a job seeker 12 with respect to a plurality of final job posting profiles 24 may be calculated by the matching system 10. The plurality of final job posting profiles 24 may be ranked based on the total weighted scores of the job seeker with respect to each final job posting profile. A list of matching final job posting profiles may then be provided to the job seeker 12 through the job seeker user interface 20b or other mechanism.

Once job seeker profiles 26 matching a final job posting profile 24 have been identified by the matching system 10, one or more job seeker profiles 26 may be presented to an employer associated with the final job posting profile 24. The employer 14 may have the ability to rank, or adjust the rankings of, the presented job seeker profiles 26 through interactions with the employer user interface 20c and those rankings may be stored in the matching system 10. The employer 14 may rank the identified job seeker profiles based on demographic information in the job seeker profiles 26, perceived further matching with respect to behavioral traits that may or may not have been considered by the matching system 10, and/or the employer 14 may rank the job seeker profiles 26 based on other criteria.

Once final job posting profiles 24 matching a job seeker profile 26 have been identified by the matching system 10, one or more final job posting profiles 24 may be presented to the job seeker 12 associated with the job seeker profile 26. The job seeker 12 may have the ability to rank the presented final job posting profiles 24 through interactions with the job seeker user interface 20b and those rankings may be stored in the matching system 10. The job seeker 12 may rank the identified final job posting profiles 24 based on demographic information in the final job posting profiles 24, perceived further matching with respect to behavioral traits that may or may not have been considered by the matching system 10, and/or the job seeker 12 may rank the final job posting profiles 24 based on other criteria, as desired.

In some instances, once a match has been made by the matching system 10 between a final job posting profile 24 and a job seeker profile 26, further functionality of the matching system 10 may be provided to the employer 14 and the job seeker 12. For example, an employer 14 associated with a final job posting profile 24 may see employer-facing profile information (e.g., attributes of the job seeker 12 such as behavioral trait scores and demographic information) within the matching system 10 of matched job seeker profiles and a job seeker 12 associated with a job seeker profile 26 may see job seeker-facing profile information (e.g., attributes of the job posting of the final job posting profile and/or employer information) within the matching system 10 of the matched final job posting profiles 24. Additionally, or alternatively, further functionality of the matching system 10 for job seekers 12 and/or employers 14 after matches are disclosed includes, but is not limited to, the ability to reject a match presented to the job seeker 12 or employer 14 by the matching system 10, the ability to contact job seekers 12 and/or employers 14 associated with a match, and/or other functionality of the matching system 10.

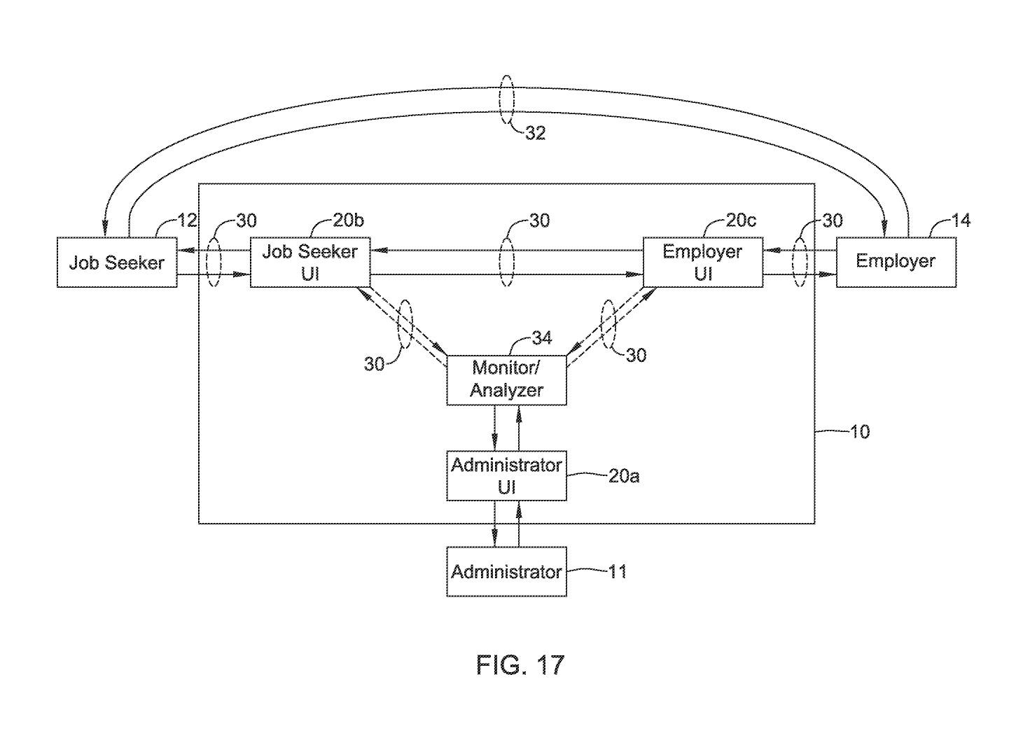

Once matched, the job seekers 12 and the employers 14 may communicate with matching system communications 30 and/or through one or more other communications 32, as shown in FIG. 17. In one example, matched job seekers 12 and employers 14 may communicate 30 through the matching system 10 with electronic mail, telephone calls, video conferences, text messaging, social networks, and/or other communication mechanisms via the job seeker user interface 20b and/or the employer user interface 20c. Alternatively, or in addition, matched job seekers 12 and employers 14 may communicate 32, as desired, without direct involvement of the matching system 10 through electronic mail, telephone calls, video conferences, text messaging, social networks, and/or other communication mechanisms.

In some instances, the functionality of the communication between the employer(s) 14 and the job seeker(s) 12 may be configured to further interview and/or weed out job seekers and/or employers. Some example matching system 10 communication 30 options may include, but are not limited to, multiple choice questions posed to the other party, fill in the blank questions posed to the other party, questions that prompt the choice or ranking of multiple answers by the other party, logic and/or word puzzles posed to the other party, open ended questions posed to the other party, audio and/or video prompted questions posed to the other party, where answers to the audio and/or video prompted questions may be recorded in audio and/or video format, general electronic mail communication between the parties, and/or other similar or dissimilar communication options.

The matching system 10 may suggest forms of or options for communication in a hierarchical manner or other manner with initial suggestions that may be broad in nature and then, further suggestions that may become more and more particular to parties engaged in communication. In this manner, the matching system 10 may be learning the relationship between the parties and may base suggestions on the development of that relationship. Illustratively, the matching system 10 may suggest one or more specific instances of communication with the intent of further refining the match between the job seeker profile 26 and the final job posting profile 24. Although the matching system 10 may make suggestions, it may allow the parties to deviate from the suggestions and may learn tendencies of how each party (e.g., each job seeker 12 and/or employer 14) acts individually and/or acts with respect to one another.

In some cases, the matching system 10 may be optionally (as represented by dotted arrows) configured to monitor or analyze 34 some or all communications between matched job seekers 12 and employers 14, as shown in FIG. 17. Alternatively, the matching system 10 may be configured to be unable to read and/or analyze communications between matched job seekers 12 and employers 14. If the matching system 10 is configured to monitor or analyze 34 some or all communications between matched job seekers 12 and employers 14, such a configuration may be monitored and/or adjusted by an administrator 11 or other user. In some cases, job seekers 12 and/or employers 14 may be able to opt-in or opt-out of allowing the matching system 10 to monitor or analyze some or all communications between itself and matched employers 14/job seekers 12.

The matching system 10 may be configured in one or more manners to monitor and/or analyze some or all communication between matched job seekers 12 and employers 14 to continuously improve, or otherwise improve over time, matching algorithms of the matching system 10, to evaluate and/or determine the truthfulness of answers provided by job seekers 12 and/or employers 14, remove job seeker 12 and/or employer 14 bias from the matching process, and/or for other purposes. For example, the matching system 10 may utilize: grammatical structure analysis and/or other analysis of written, audio, and/or video communications by job seekers 12 to evaluate whether a job seeker's communications correlate to what would be expected of the job seeker 12 with its demographic attributes (e.g., education level or other demographic attributes) in the job seeker profile 26 and/or such behavioral trait attributes as those computed by the matching system 10 for the job seeker 12; speech pattern analysis and/or other analysis of audio and/or video communications by job seekers 12 to evaluate and/or determine whether a job seeker's voice and/or speech patterns have the same or similar behavioral traits associated therewith as were associated with the job seeker's profile 26; facial and body language analyses and/or other analysis of video communications by job seekers 12 to facilitate evaluating whether a job seeker 12 is providing truthful communications. Alternatively, or in addition, the matching system 10 may utilize: grammatical structure analysis and/or other analysis of written, audio, and/or visual communications by the employer 14 to evaluate and/or determine whether the employer's 14 communications exhibit traits that correlate with a description of an open position, company atmosphere, and/or other working conditions in an employer's final job posting profile 24; and/or the matching system 10 may utilize speech pattern analysis, facial analysis, body language analysis, and/or other analyses of video communications of the employer 14 to evaluate and/or determine whether the employer's 14 speech patterns and/or body language correlate in one or more manners with the employer's 14 description of the employer, the working environment, the particular open position of a final job posting profile 24, and/or other description in the job posting of the final job posting profile 24.

The matching system 10 may allow either party to terminate communication 30 through the matching system 10 unilaterally. For example, the employer 14 may determine it is no longer interested in a job seeker 12 for its open job posting and unilaterally decide to cease communication. The job seeker 12 may determine it is no longer interested in pursuing an open job posting and unilaterally decide to cease communication. The ability to cease communication may facilitate making employment decisions without receiving undesired feedback from the job seeker 12 or the employer 14 with which communication was cut-off

In some instances, an employer 14 may be able to close a final job posting profile 24, indicate whether or not the final job posting profile 24 was filled, and/or with which job seeker profile 26 the final job posting profile 24 was filled, if it was filled. In some instances, the algorithms of the matching system 10 may be automatically or manually modified to learn from and/or account for successful and/or unsuccessful job seeker profile 26 and final job posting profile 24 matches presented by the matching system 10. Such adjustment of the algorithms of the matching system 10 may facilitate increasing the accuracy of matching job seeker profiles 26 with final job posting profiles 24 by the matching system 10 over time (e.g., where accuracy may be measured from communications between the job seeker 12 and/or the employer 14 and/or matches that lead to successful hires) and/or adjusting rankings of matches in real time in response to an action taken (e.g., communication, rejection, acceptance, or other action) by a job seeker 12 or an employer 14.

Although certain steps of the system or methods of operation may be discussed herein in one or more particular orders, it is contemplated that one or more systems or methods of operation may follow these steps in similar or other orders (including a plurality of steps being performed simultaneously), may include one or more further steps, and/or may include further steps in one or more orders.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A system comprising:
a processor;
a memory including a set of instructions executable by the processor, wherein executing the instructions configures the processor to:
create an initial job posting profile from answers to one or more initial job posting questions posed to an employer, the initial job posting questions relating to a job posting by the employer and the initial job posting profile including one or more attributes of a desirable job seeker;
process a review by the employer of the initial job posting profile;
from the review by the employer of the initial job posting profile, create a final job posting profile in view of the processed review by the employer, the final job posting profile including one or more attributes of a desirable job seeker;
process answers from one or more job seekers, the answers are responses to one or more survey questions and one or more answers relate directly, indirectly, or indirectly and directly to one or more attributes of the one or more job seekers;
create a job seeker profile from the processed answers to the one or more survey questions for each job seeker, the job seeker profiles form a job seeker database;
compare one or more job seeker profiles from the job seeker database to the final job posting profile to create a list of top job seekers.

2. The system of claim 1, wherein the one or more attributes of the desirable job seeker for the final job posting profile includes one or more behavioral traits of the desirable job seeker for the final job posting profile.

3. The system of claim 1, wherein the one or more attributes of the desirable job seeker for the final job posting profile includes up to ten behavioral traits of the desirable job seeker that are ordered by most desirable behavioral trait to least desirable behavioral trait.

4. The system of claim 1, wherein executing the instructions configures the processor to assign a weight to one or more of the attributes of the desirable job seeker in the initial job posting profile.

5. The system of claim 1, wherein executing the instructions configures the processor to process a review of the initial job posting profile that includes approval of one or more attributes in the initial job posting profile, a modification of one or more attributes in the initial job posting profile, approval of an order of one or more attributes in the initial job posting profile, and/or modification of an order of one or more attributes of in the initial job posting profile.

6. The system of claim 1, wherein one or more of the job seeker profiles includes a list of one or more behavioral traits of the job seeker.

7. The system of claim 6, wherein the processed answers are utilized to score each of the one or more behavioral traits of the job seeker.

8. The system of claim 7, wherein to compare one or more job seeker profiles from the job seeker database to the final job posting profile to create a list of top job seekers, executing the instructions configures the processor to compare the scores of each of the one or more behavioral traits of the job seeker to the one or more attributes of the desirable job seeker in the final job posting profile.

9. The system of claim 1, wherein:
the one or more attributes of a desirable job seeker in the final job posting profile includes one or more demographic ideals for the desirable job seeker;
the one or more attributes of each job seeker profile includes one or more demographic preferences for the job seeker; and
to compare one or more job seeker profiles from the job seeker database to the final job posting profile to create a list of top job seekers, executing the instructions configures the processor to compare demographic ideals of the final job posting profile to demographic preferences of the one or more job seeker profiles.

10. A matching system for matching job seekers with job postings and/or job postings with job seekers, the matching system comprising:
a job posting profile module including one or more job posting profiles, wherein a job posting profile includes one or more behavioral traits of a desirable job seeker;
a job seeker profile module including one or more job seeker profiles, wherein a job seeker profile comprises an associated job seeker's answers to survey questions related to one or more behavioral traits;
a processor in communication with the job posting profile module and the job seeker profile module; and
wherein the processor is configured to create for a job seeker profile a trait score for one or more behavioral traits of the desirable job seeker of a job posting profile.

11. The system of claim 10, wherein the processor is configured to create for each job seeker profile a trait score for each of the one or more behavioral traits of the desirable job seeker of the job posting profile.

12. The system of claim 10, wherein
each behavioral trait included in a job posting profile has an intensity level associated therewith; and
each job seeker profile has answers to questions of a sub-set of survey questions for each of one or more behavioral traits included in a job posting profile.

13. The system of claim 12, wherein:
the processor is configured to determine a trait score of a job seeker profile for each of one or more behavioral traits of the job posting profile;
the trait scores are based, at least in part, on a difference between answers to one or more of the questions of the sub-set of survey questions associated with the behavioral trait of the job posting profile and a target answer for each of those one or more questions; and
the target answer for each of those questions is based, at least in part, on an intensity level of the behavioral trait of the job posting profile.

14. The system of claim 13, wherein the processor is configured to:
for one or more of the questions of the sub-set of survey questions, assign a numerical value to the difference between an answer to a question of the sub-set of survey questions and a target answer for the question based, at least in part, on a scoring matrix; and
determine the trait score for a behavioral trait of the job posting profile by, at least in part, summing the assigned numerical values and dividing the sum of the assigned numerical values by a sum of a total possible numerical value for the differences between each job seeker answer to the one or more questions of the sub-set of survey questions and the target answers for those questions based on the scoring matrix.

15. The system of claim 13, wherein the processor is configured to determine a weighted trait score for each trait score determined for a job seeker profile with respect to one or more behavioral traits of the job posting profile.

16. The system of claim 15, wherein:
the weighted trait score is determined by applying a weight associated with a behavioral trait to the trait score determined for a job seeker with respect to the behavioral trait; and
the weight associated with a behavioral trait is based, at least in part, on a ranking of importance of the behavioral trait with respect to one or more other behavioral traits associated with the job posting profile.

17. The system of claim 15, wherein the processor is configured to determine a weighted match score for the job seeker profile with respect to the job posting profile based, at least in part, on the weighted trait scores of the behavioral traits associated with the job posting profile.

18. A method of matching one or more job seekers with a job posting, the method comprising:
creating an initial job posting profile, the initial job posting profile is created from answers to one or more initial job posting questions posed to an employer and relating to a job posting of the employer, the initial job posting profile including one or more attributes of a desirable job seeker;
processing a review by the employer of the initial job posting profile;
from the processed review by the employer of the initial job posting profile, creating a final job posting profile in a job posting database, the final job posting profile including one or more attributes of a desirable job seeker;
processing answers from one or more job seekers, the answers are responses to one or more survey questions and one or more answers relate directly, indirectly, or indirectly and directly to one or more attributes of the one or more job seekers;
creating a job seeker profile from the processed answers to the one or more survey questions for each job seeker, the job seeker profiles form a job seeker database;
comparing with a processor in communication with the job posting database and the job seeker database one or more job seeker profiles to the final job posting profile to create a list of top job seekers for the final job posting profile.

19. The method of claim 18, further comprising:
weighting one or more attributes of a desirable job seeker in the initial job posting profile.

20. The method of claim 18, further comprising:
adjusting a weight of one or more attributes of a desirable job seeker in response to one or more actions taken by the employer during a review of the initial job posting profile.
